(19) United States
(12) Patent Application Publication
(10) Pub. No.: US 2020/0186557 A1
(43) Pub. Date: Jun. 11, 2020

(54) NETWORK ANOMALY DETECTION APPARATUS, NETWORK ANOMALY DETECTION SYSTEM, AND NETWORK ANOMALY DETECTION METHOD

(71) Applicant: ALAXALA Networks Corporation, Kawasaki-shi (JP)

(72) Inventors: Yuichi ISHIKAWA, Kawasaki (JP); Nobuhito MATSUYAMA, Kawasaki (JP)

(21) Appl. No.: 16/680,757

(22) Filed: Nov. 12, 2019

(30) Foreign Application Priority Data
Dec. 5, 2018 (JP) 2018-228475

(51) Int. Cl. H04L 29/06; G06F 17/18

(52) U.S. Cl. CPC H04L 63/1425; G06F 17/18; H04L 69/22

(57) ABSTRACT

A network anomaly detection apparatus configured to detect an anomaly of a network to be monitored based on received flow statistical information, the network anomaly detection apparatus including a processor, a memory, a statistical information collection unit, an anomaly detection unit and scenario information. The statistical information collection unit configured to receive flow statistical information aggregated from header information of packets in the network and collect the flow statistical information in a flow statistical information storage unit. Scenario information including a scenario in which a time-series sequential relation of events concerning a plurality of flows is defined. The anomaly detection unit configured to acquire flow statistical information in a predetermined period from the flow statistical information storage unit and determine whether any anomaly exists in the network based on whether any flow statistical information matching the events in the scenario of the scenario information exists.

### CLAIM OF PRIORITY

The present application claims priority from Japanese patent application JP 2018-228475 filed on Dec. 5, 2018, the content of which is hereby incorporated by reference into this application.

### BACKGROUND OF

This invention relates to an apparatus having a function to detect a network anomaly.

Security risks are increasing that are caused by cyber-attacks such as distributed denial of service (DDoS) attacks and targeted attacks.

A targeted attack has a procedure; a series of attacker's procedure is called a cyber kill chain. Known examples of the cyber kill chain are described in the following Non-patent Documents 1, 5, and 6 listed below.

A cyber kill chain includes the following attacking steps: Reconnaissance (collecting information on the target), Weaponization (creating attack codes or malware), Delivery (sending the created attack codes or malware to the target via a website, for example), Exploitation (exploiting the target to execute the malware), Installation (installing the malware to the target), Command and Control (C & C) (activating remote-control, expanding the infection, and searching for internal information through communication from a C & C server to a malware-infected terminal), and Actions on Objective (taking information from a server by the malware-infected terminal).

A targeted attack can be detected by detecting a part or all of these attacking steps. To detect a single attack step, there is an approach of analyzing the behavior of communication to detect characteristic communication of the attacking step of a cyber kill chain.

The known existing technology for analyzing the behavior of communication includes flow statistics that takes statistics of the communication on a flow-by-flow basis. A flow is determined by the information in each packet header. To take flow statistics, features such as NetFlow (for example, Non-Patent Document 2) and sFlow (for example, Non-Patent Document 3) are known. Meanwhile, mirroring that collects packets themselves transmitted in communication is also known (for example, Non-Patent Document 4).
Non-Patent Document 1: “Technical Aspects of Cyber Kill Chain”, Tarun Yadav, Rao Arvind Mallari, International Symposium on Security in Computing and Communication, SSCC 2015, Security in Computing and Communications pp 438-452.
Non-Patent Document 2: RFC3954, “Cisco Systems NetFlow Services Export Version 9”, Cisco Systems, October 2004.
Non-Patent Document 3: RFC3176, “InMon Corporation's sFlow: A Method for Monitoring Traffic in Switched and Routed Networks”, InMon Corp, September 2001.
Non-Patent Document 4: “Policy Based Mirroring Function”, ALAXALA Networks Corporation.
Non-Patent Document 5: “DNS traffic analysis for botnet detection focusing on queries from the same domain”, Akimoto et al, Record of 2012 Joint Conference of Electrical and Electronics Engineers in Kyushu.
Non-Patent Document 6: “A Holistic Perspective on Understanding and Breaking Botnets: Challenges and Countermeasures”, Zhang Zonghua and KADOBAYASHI Youki, National Institute of Information and Communications Technology, Journal of NICT Vol. 54, 2008.

### SUMMARY

To detect a cyber kill chain, it is required to detect communication between a C & C server and a malware-infected terminal corresponding to the attacking step of C & C in a cyber kill chain and subsequent communication between the malware-infected terminal and a server corresponding to the attacking step of Actions on Objective.

Generalizing the foregoing, detecting events each concerning a different flow and occurring sequentially (in a specific order) is required to detect a cyber kill chain.

However, the aforementioned documents about communication behavior analysis utilizing the flow statistics or mirroring do not disclose such a function to detect a cyber kill chain. Accordingly, the existing techniques have a problem that events each concerning a different flow and occurring sequentially cannot be detected even though individual events concerning different flows can be detected.

For solving the above problem, a network anomaly detection apparatus configured to detect an anomaly of a network to be monitored based on received flow statistical information, the network anomaly detection apparatus including a processor, a memory, a statistical information collection unit, an anomaly detection unit and scenario information. The statistical information collection unit configured to receive flow statistical information aggregated from header information of packets in the network and collect the flow statistical information in a flow statistical information storage unit. Scenario information including a scenario in which a time-series sequential relation of events concerning a plurality of flows is defined. The anomaly detection unit configured to acquire flow statistical information in a predetermined period from the flow statistical information storage unit and determine whether any anomaly exists in the network based on whether any flow statistical information matching the events in the scenario of the scenario information exists.

This invention enables detection of events each concerning a different flow and further, detection of an anomaly (such as a cyber kill chain) of a monitoring target network occurring under the condition that the events concerning the different flows occur sequentially.

At least one embodiment of the idea to be disclosed in this specification will be described in detail in the following description while referencing the accompanying drawings. Other features, aspects, and effects of the idea to be disclosed are clarified in the following disclosure, the drawings, and the claims.

### BRIEF DESCRIPTION OF THE DRAWINGS

FIG. 1 is a block diagram of a network anomaly detection system including a network anomaly detection apparatus according to a first embodiment of this invention.

FIG. 2 is a block diagram of the network anomaly detection apparatus according to the first embodiment of this invention.

FIG. 3 is a configuration diagram of a packet according to the first embodiment of this invention.

FIG. 4 is a configuration diagram of the flow statistics database according to the first embodiment of this invention.

FIG. 5 is a configuration diagram of the scenario table according to the first embodiment of this invention.

FIG. 6 illustrates an example of the SYSLOG DB according to the first embodiment of this invention.

FIG. 7A is a former half of a flowchart illustrating an example of processing performed by the network abnormality detection apparatus according to the first embodiment of this invention.

FIG. 7B is a latter half of a flowchart illustrating an example of processing performed by the network abnormality detection apparatus according to the first embodiment of this invention.

FIG. 8A is a former half of a flowchart illustrating a modified example of processing performed by the network abnormality detection apparatus according to the first embodiment of this invention.

FIG. 8B is a latter half of a flowchart illustrating a modified example of processing performed by the network abnormality detection apparatus according to the first embodiment of this invention.

FIG. 9 is a block diagram of a network anomaly detection system including a network anomaly detection apparatus to illustrate a modification of the first embodiment.

FIG. 10 is a block diagram illustrating an example of the configuration of a network anomaly detection system according to a second embodiment of this invention.

FIG. 11 is a sequence diagram illustrating an example of the flows occurring sequentially in the network when the above-described information leakage occurs according to the second embodiment of this invention.

FIG. 12A is a graph showing examples of bandwidth variation in a network caused by Flow One when information leakage occurs according to the second embodiment of this invention.

FIG. 12B is a graph showing examples of bandwidth variation in a network caused by Flow Two when information leakage occurs according to the second embodiment of this invention.

FIG. 13 illustrates an example of a scenario entry 21 in the scenario table 20 for information leakage detection according to the second embodiment of this invention.

FIG. 14A is a first part of a flowchart illustrating an information leakage detection processing performed by the network abnormality detection apparatus according to the second embodiment of this invention.

FIG. 14B is a second part of a flowchart illustrating an information leakage detection processing performed by the network abnormality detection apparatus according to the second embodiment of this invention.

FIG. 14C is a third part of a flowchart illustrating an information leakage detection processing performed by the network abnormality detection apparatus according to the second embodiment of this invention.

FIG. 14D is a fourth part of a flowchart illustrating an information leakage detection processing performed by the network abnormality detection apparatus according to the second embodiment of this invention.

FIG. 15 is a block diagram illustrating an example of the configuration of a network anomaly detection system that allows detection of a botnet with the network anomaly detection apparatus according to a third embodiment of this invention.

FIG. 16 is a sequence diagram illustrating an example of the flows occurring sequentially in the network when the attack activity of a botnet occurs according to the third embodiment of this invention.

FIG. 17A is a graph showing a relation between the bandwidth from a botnet to the DNS server and the time according to the third embodiment of this invention.

FIG. 17B is a graph showing a relation between the bandwidth from a botnet to the C & C server and the time according to the third embodiment of this invention.

FIG. 18 illustrates an example of a scenario entry in the scenario table according to the third embodiment of this invention.

FIG. 19A is a first part of a flowchart illustrating a botnet detection processing performed by the network abnormality detection apparatus according to the third embodiment of this invention.

FIG. 19B is a second part of a flowchart illustrating a botnet detection processing performed by the network abnormality detection apparatus according to the third embodiment of this invention.

FIG. 19C is a third part of a flowchart illustrating a botnet detection processing performed by the network abnormality detection apparatus according to the third embodiment of this invention.

FIG. 19D is a fourth part of a flowchart illustrating a botnet detection processing performed by the network abnormality detection apparatus according to the third embodiment of this invention.

FIG. 20 illustrates an example of a user interface for editing (adding or deleting) a scenario entry in the scenario table according to the first embodiment of this invention.

### DETAILED DESCRIPTION OF THE EMBODIMENTS

Hereinafter, embodiments of this invention will be described based on the accompanying drawings.

### Embodiment 1

Embodiment 1 of this invention describes a configuration example of a network anomaly detection system of this invention including a network anomaly detection apparatus 100 and an apparatus configuration of the network anomaly detection apparatus 100 of this invention.

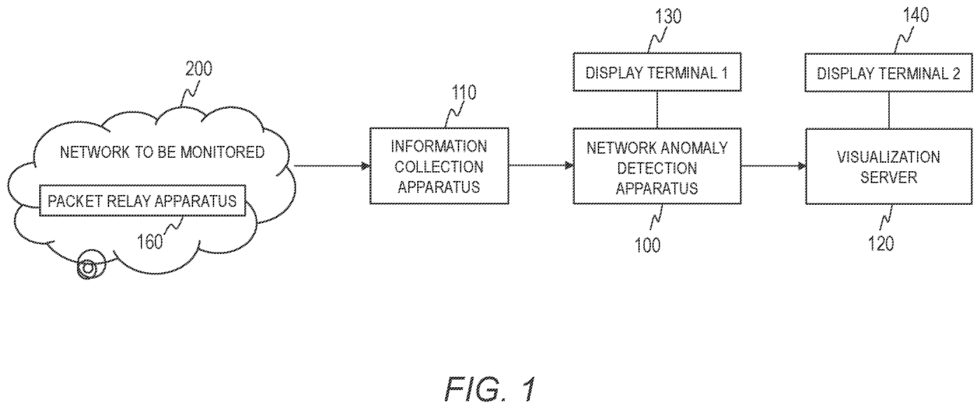

FIG. 1 is a block diagram of a network anomaly detection system including a network anomaly detection apparatus 100 of this invention.

A packet relay apparatus 160 (or a network TAP (mirroring apparatus)) in a network 200 to be monitored sends mirror packets generated from the packets being monitored with its mirroring function to an information collection apparatus 110.

The information collection apparatus 110 organizes statistical information such as the number of packets and the number of bytes by flow that is defined by the header information of each mirror packet and sends this information to the network anomaly detection apparatus 100 as flow statistical information.

To acquire flow statistical information, NetFlow defined in RFC3954 can be used. The network anomaly detection apparatus 100 accumulates the flow statistical information received from the information collection apparatus 110 to a flow statistics database 50 to analyze whether the network 200 exhibits any anomaly based on the accumulated flow statistical information.

Upon detection of an anomaly in the network 200, the network anomaly detection apparatus 100 displays information on the detected network anomaly on its display terminal 130.

The network anomaly detection apparatus 100 further sends the information on the detected network anomaly to a visualization server 120 as a SYSLOG. The visualization server 120 is connectable to other security apparatuses and therefore, it can display information about the network anomaly detected by the network anomaly detection apparatus 100 on a display terminal 140 in association with information on the communication traffic or information on incidents acquired by other apparatuses (not shown).

As a result, the location of the anomaly of the network 200 detected by the network anomaly detection apparatus 100 and information on the communication traffic and incidents before and after the occurrence of the network anomaly can be analyzed at the visualization server 120, allowing information about the network anomaly to be displayed from more perspectives.

In FIG. 1, the information collection apparatus 110, the network anomaly detection apparatus 100, and the visualization server 120 are interconnected via a not-shown network.

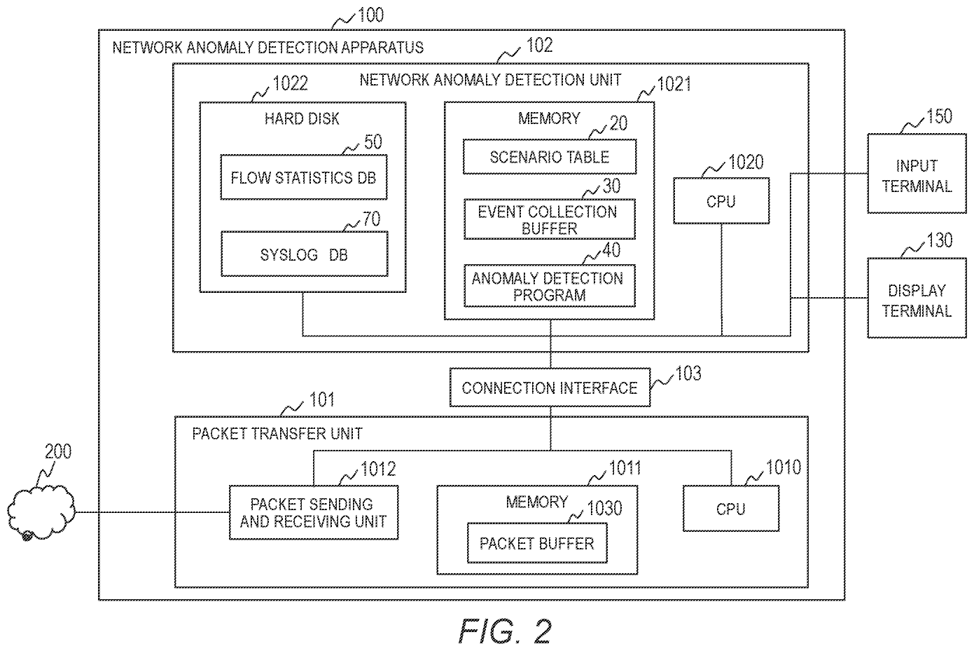

FIG. 2 is a block diagram of the network anomaly detection apparatus 100 of this invention. The network anomaly detection apparatus 100 includes a packet transfer unit 101 for receiving and outputting packets from and to the information collection apparatus 110 or the visualization server 120, a network anomaly detection unit 102 for analyzing flow statistical information received from the information collection apparatus 110 to detect an anomaly in the network 200, and a connection interface 103 for connecting the packet transfer unit 101 and network anomaly detection unit 102.

The packet transfer unit includes a CPU 1010, a memory 1011, and a packet sending and receiving unit 1012. The memory 1011 is configured to include a packet buffer 1030. A packet processing program (not shown) is loaded to the memory 1011 and executed by the CPU 1010.

The network anomaly detection unit 102 includes a CPU 1020, a memory 1021, and a hard disk 1022. The network anomaly detection unit 102 is connected with an input terminal 150 and a display terminal 130.

The memory 1011 stores a scenario table 20, an event collection buffer 30, and an anomaly detection program 40. The anomaly detection program 40 is executed by the CPU 1020. The hard disk 1022 stores a flow statistics database 50 and a SYSLOG database 70.

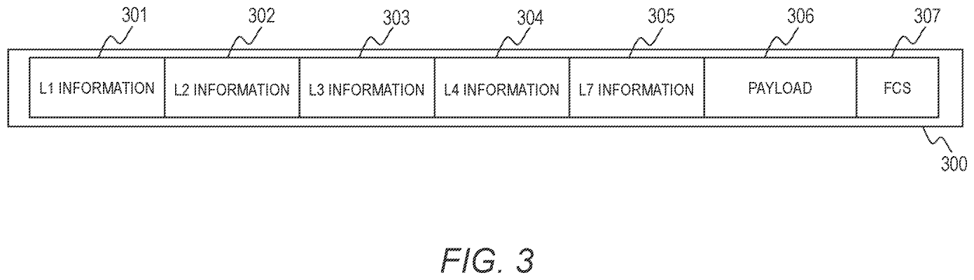

FIG. 3 is a configuration diagram of a packet 300. A packet 300 is composed of Layer 1 (L1) information 301, Layer 2 (L2) information 302, Layer 3 (L3) information 303, Layer 4 (L4) information 304, Layer 7 (L7) information 305, a payload 306, and a frame check sequence (FCS) 307.

In the case of Ethernet (Ethernet is a registered trademark; the same applies hereinafter), the L1 information 301 includes an interframe gap (IFG) and a preamble.

The L2 information 302 includes Ethernet header information and VLAN tag information. The L3 information 303 includes IP header information. The L4 information 304 includes TCP header information or UDP header information. The L7 information 305 includes http header information or mail header information.

In the case where the packet 300 is a flow statistics packet by the aforementioned NetFlow, the packet 300 is usually an UDP packet and the flow statistical information by NetFlow is stored in the L7 information 305.

With reference back to FIG. 2, when a packet 300 is input to the packet sending and receiving unit 1012 in the packet transfer unit 101, packet reception processing starts.

Upon receipt of a packet 300, the packet sending and receiving unit 1012 notifies the CPU 1010 of the receipt of the packet 300 and writes the content of the packet 300 to the packet buffer 1030.

When notified of receipt of a packet 300, the CPU 1010 retrieves the packet 300 from the packet buffer 1030. If the packet 300 contains NetFlow flow statistical information, the CPU 1010 forwards the NetFlow flow statistical information in the packet 300 to the network anomaly detection unit 102 through the connection interface 103 connecting the packet transfer unit 101 and the network anomaly detection unit 102.

When the network anomaly detection unit 102 receives the NetFlow flow statistical information of the packet 300, the CPU 1020 stores the NetFlow flow statistical information of the packet 300 to the memory 1021 on a temporary basis.

The CPU 1020 retrieves the NetFlow flow statistical information of the packet 300 from the memory 1021 at an appropriate time and stores it to the flow statistics DB 50 in the hard disk 1022.

The CPU 1020 performs processing in accordance with the program of each function unit to work as a function unit for providing a predetermined function. For example, the CPU 1020 performs processing in accordance with the anomaly detection program 40 to function as an anomaly detection unit. The same applies to the other programs. Furthermore, the CPU 1020 works as the function units for providing the functions of a plurality of processes executed by each program. A computer and a computer system are an apparatus and a system including these function units.

Through the above-described processing, flow statistical information of the packets collected by the information collection apparatus 110 is accumulated in the flow statistics database 50 in the network anomaly detection apparatus 100.

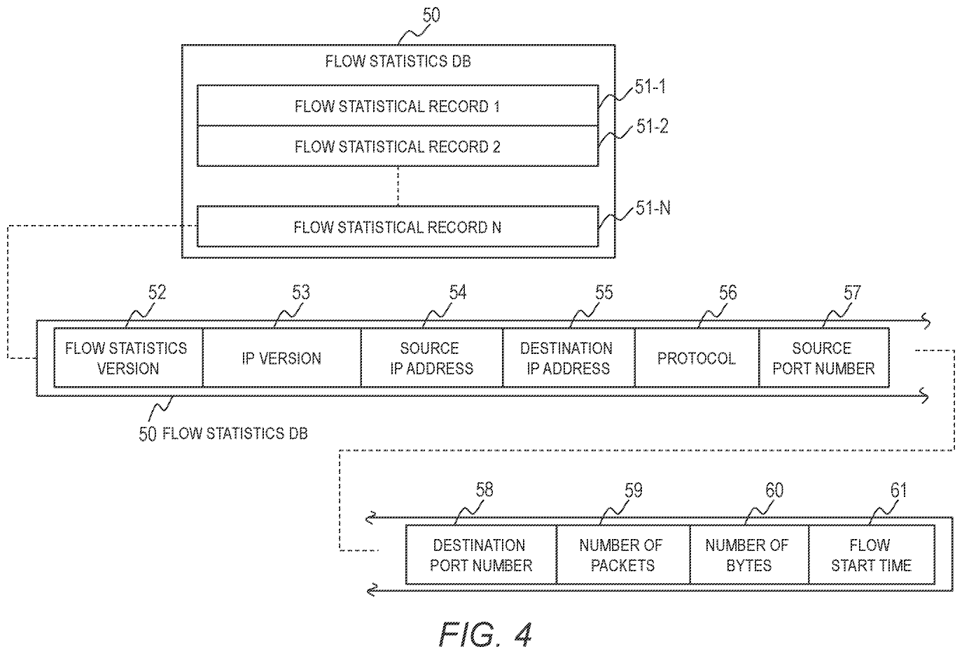

FIG. 4 is a configuration diagram of the flow statistics database (hereinafter, DB) 50. The flow statistics DB 50 consists of N entries of flow statistical information of a flow statistical record 1 (51-1), a flow statistical record 2 (51-2), . . . , and a flow statistical record N (51-N). In the following description, when not referring to a specific flow statistical record, a reference sign 51 without a suffix followed by “-” is used for a flow statistical record. The same applies to the reference signs of the other elements.

A flow statistical record 51 can include any of the L2 information, L3 information, L4 information, and L7 information; this embodiment describes an example including information in the L3 information and the L4 information.

A flow statistical record 51 includes a flow statistics version 52 indicating the version of the flow statistics standard, the IP version 53 of the monitored packets, the source IP address 54 of the packets, the destination IP address 55 of the packets, the protocol 56 in the L4 information of the packets, the source port number 57 in the L4 information of the packets, the destination port number 58 in the L4 information of the packets, the number of packets 59 in the flow, the number of bytes 60 of the packets in the flow, and the flow start time 61.

The CPU 1020 of the network anomaly detection unit 102 retrieves flow statistical records 51 whose flow start times 61 are included within a predetermined period or a period specified by the operation administrator of the network anomaly detection apparatus 100 from the flow statistics DB 50 at every interval equal to the period and stores the retrieved flow statistical records 51 to the event collection buffer 30 in the memory 1021.

In other words, the CPU 1020 extracts the latest flow statistical records 51 from the flow statistics DB 50 at every predetermined time interval and stores them to the event collection buffer 30.

The anomaly detection program 40 detects an anomaly of the network 200 based on the information in the plurality of flow statistical records 51 stored in the event collection buffer 30 and the scenario table 20.

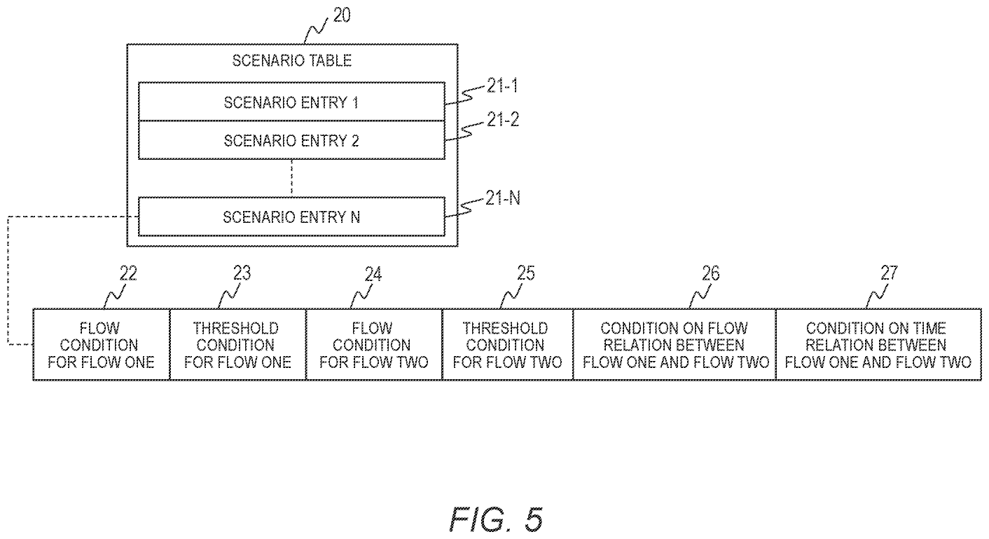

FIG. 5 is a configuration diagram of the scenario table 20. The scenario table 20 consists of a plurality of scenario entries 21-1 to 21-N. The scenario table 20 is a table for detecting an anomaly in the network 200 and specifies conditions to determine that a second event (referred to as Flow Two) occurs after a first event (referred to as Flow One) within the flow statistical records 51.

The network anomaly detection apparatus 100 in Embodiment 1 determines that an anomaly has occurred when the first event (the flow condition for Flow One) occurs (satisfies the threshold condition for Flow One) and then the second event (the flow condition for Flow Two) occurs (satisfies the threshold condition for Flow Two); however, the conditions for an anomaly is not limited to this example. More events such as the third event or the fourth event can be specified in the scenario table 20.

The network anomaly detection apparatus 100 determines that the anomaly specified in a scenario entry 21 occurs in the network 200 if the first event and the second event occur and further, the occurrence of the first event and the occurrence of the second event satisfy a predetermined sequential relation (time relation).

Each of the scenario entries 21-1 to 21-N includes a flow condition 22 for Flow One, a threshold condition 23 for Flow One, a flow condition 24 for Flow Two, a threshold condition 25 for Flow Two, a condition 26 on the flow relation between Flow One and Flow Two, and a condition 27 on the time relation between Flow One and Flow Two.

A scenario entry 21 can be configured to correspond to steps of a cyber kill chain. For example, the scenario entry 21-1 can be a scenario for detecting information leakage and the scenario entry 21-2 can be a scenario for detecting a botnet.

For example, a scenario entry 21-1 for detecting information leakage can be configured as follows: the flow conditions 22 for Flow One are that the source is a specific server and the destination is a PC in the network 200; the flow conditions 24 for Flow Two are that the source is a PC in the network 200 and the destination is a computer outside the network 200; the threshold condition 23 for Flow One and the threshold condition 25 for Flow Two are specified in bytes; the condition 26 on the flow relation between Flow One and Flow Two is that the destination address of Flow One is the same as the source address of Flow Two; and the condition 27 on the time relation between Flow One and Flow Two is that Flow Two is executed within a specified period after Flow One is executed.

The scenario entries 21-1 to 21-N can be configured with all or a part of the conditions from the flow condition 22 to the condition 27 on the time relation. The scenario entries 21 are configured by the operation administrator of the network anomaly detection apparatus 100 through the input terminal 150.

The CPU 1020 executing the anomaly detection program 40 retrieves all scenario entries 21 from the scenario table 20 in the memory 1021 and extracts combinations of flow statistical records 51 matching the conditions specified in each scenario entry 21 from the flow statistical records 51 stored in the event collection buffer 30.

The CPU 1020 determines that the flows corresponding to the flow statistical records 51 matching the conditions specified in a scenario entry 21 is an anomaly occurring in the network 200.

In determining an anomaly, the CPU 1020 first determines Flow One's that occur earlier based on the condition 26 on the flow relation between Flow One and Flow Two and the condition 27 on the time relation between Flow One and Flow Two by examining the flow statistical records in the flow statistics DB 50 to select flows that satisfy the flow condition 22 for Flow One and the threshold condition 23 for Flow One as Flow One's.

That is to say, the CPU 1020 selects flows satisfying the flow condition 22 for Flow One and the threshold condition 23 for Flow One from the flow statistical records in the flow statistics DB 50 as Flow One's and stores them to the event collection buffer 30.

The CPU 1020 further determines whether any Flow Two that satisfies the flow condition 24 for Flow Two, the threshold condition 25 for Flow Two, and the condition 26 on the flow relation between Flow One and Flow Two exists in the flow statistical records in the flow statistics DB 50.

Assuming that the flows satisfying the condition 26 on the flow relation between Flow One and Flow Two are Flow Two's, the CPU 1020 further determines whether each Flow Two satisfies the condition 27 on the time relation between Flow One and Flow Two and registers the flows satisfying the condition to the event collection buffer 30.

Through the above-described processing (network anomaly detection algorithm 1), a network anomaly can be detected with a combination of a Flow One and a Flow Two registered in the event collection buffer 30. The CPU 1020 displays the Flow One and the Flow Two with which a network anomaly is detected on the display terminal 130 to inform the operation administrator of the network anomaly detection apparatus 100 of the flows in the network 200 where an anomaly is detected.

The CPU 1020 also creates a SYSLOG from the Flow One and the Flow Two in the network 200 with which the anomaly is detected and sends the SYSLOG to the visualization server 120. Accordingly, the operation administrator of the network anomaly detection system perceives the flows with which a network anomaly is detected through the display terminal 140 of the visualization server 120.

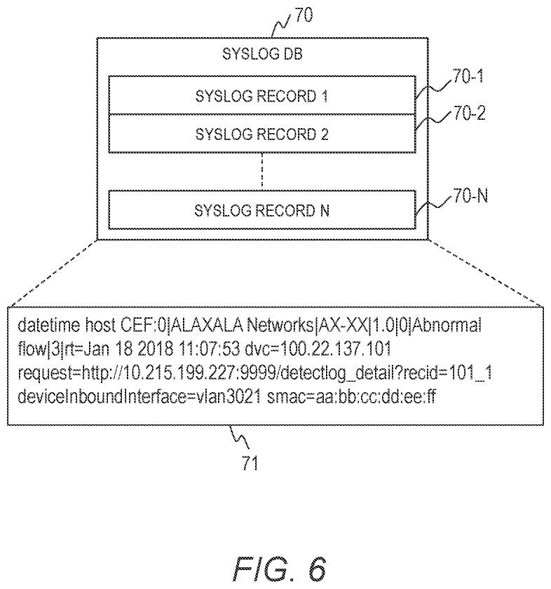

FIG. 6 illustrates an example of the SYSLOG DB 70. A SYSLOG in Embodiment 1 stores information in the common event format (CEF), which is used to send security information. The network anomaly detection apparatus 100 sends it to the visualization server 120.

The SYSLOG DB 70 consists of a SYSLOG record 1 (70-1), a SYSLOG record 2 (70-2), . . . and a SYSLOG record N (70-N).

Each of the SYSLOG records 70-1 to 70-N includes a SYSLOG 71. In a SYSLOG 71, “datetime” indicates the time when the SYSLOG 71 is created; “host” indicates the IP address or the name of the host that creates the SYSLOG 71; “CEF: 0” is the version of the CEF; “ALAXALA Networks” is the vendor's name of the network anomaly detection apparatus 100; “AX-XX” is the apparatus name of the network anomaly detection apparatus 100; and “1.0” is the version of the network anomaly detection apparatus 100.

Further in the SYSLOG 71, “0” is an event type ID; “Abnormal flow” is the type name of the detected network anomaly; “3” is a severity level; “rt” is followed by the time of occurrence of the network anomaly; “dvc” is followed by the IP address of the network anomaly detection apparatus 100 where the network anomaly has occurred; “request” is followed by the URL where detailed information on the detected network anomaly is stored; “deviceInboundInterface” is followed by the information on the VLAN or the line where the network anomaly has occurred; and “smac” is followed by the source MAC address of the detected network anomaly.

The SYSLOG 71 can also include the destination MAC address, the source IP address, the destination IP address, the protocol, the destination port number, and/or the source port number of the detected network anomaly; the threshold value and the type of the threshold used to detect the anomaly; and the packet rate, the byte rate, the number of different destination IP addresses, the number of different source IP addresses, the number of different destination MAC addresses, and/or the number of different source MAC addresses with which the anomaly is detected.

The number of different destination IP addresses is the number of destination IP addresses included in the flow statistical records collected by the network anomaly detection apparatus 100. The like applies to the number of different source IP addresses and the others.

The SYSLOG 71 sent by the network anomaly detection apparatus 100 in the format shown in FIG. 6 can be displayed on the display terminal 1 (130) connected with the network anomaly detection apparatus 100.

In addition, the visualization server 120 in receipt of the SYSLOG 71 sent in the format shown in FIG. 6 by the network anomaly detection apparatus 100 graphically visualizes the information on the network anomaly stored in the SYSLOG 71 on the display terminal 2 (140) connected with the visualization server 120.

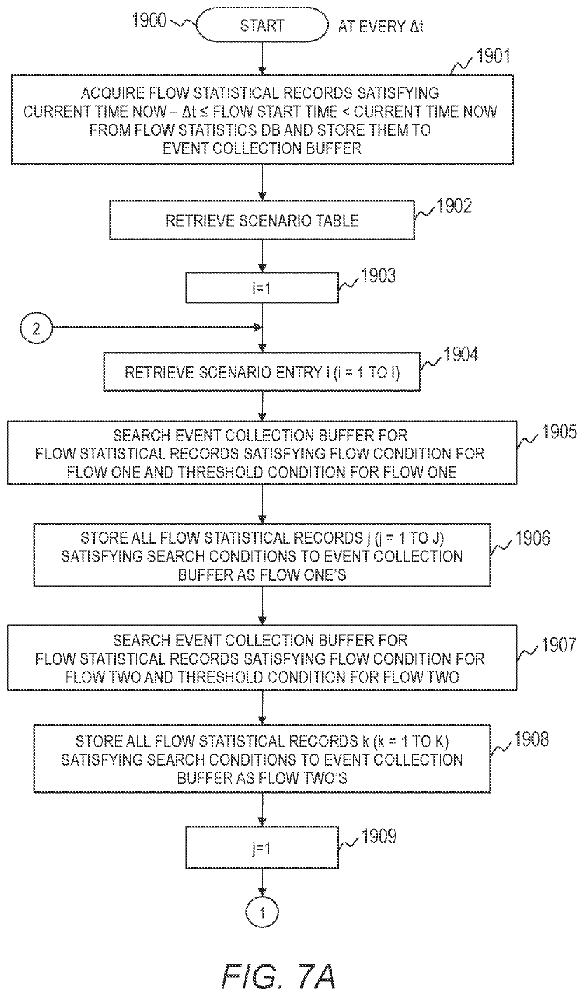

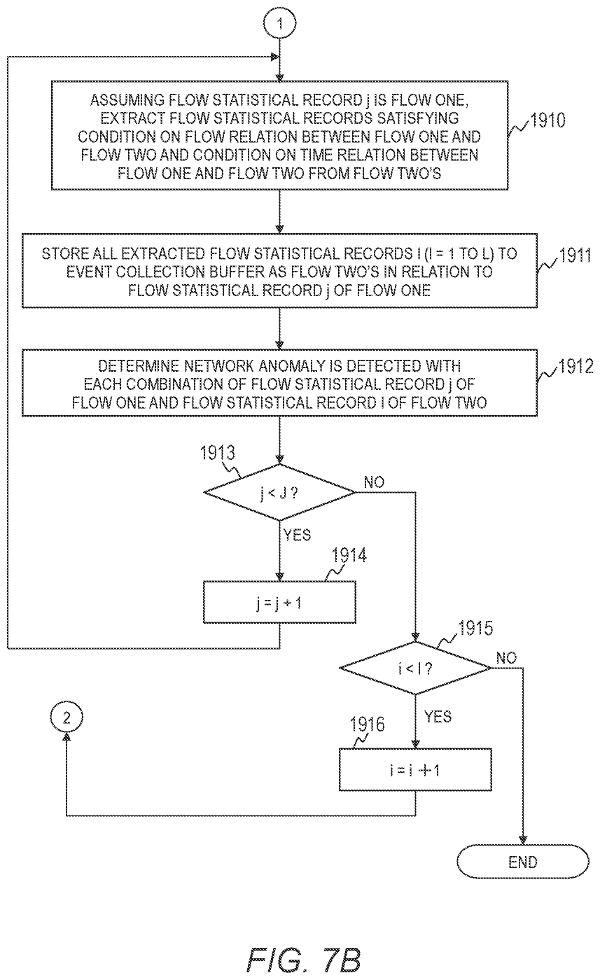

The flowchart of FIGS. 7A and 7B illustrates an example of the processing of the anomaly detection program 40 to be executed by the CPU 1020. The following description employs the CPU 1020 as the agent of the processing; however, the anomaly detection program 40 (anomaly detection unit) or the network anomaly detection apparatus 100 can be the agent of the processing.

At Step 1900, the CPU 1020 starts processing at every predetermined time interval of Δt.

At the next Step 1901, the CPU 1020 searches the flow statistics DB 50 for flow statistical records 51 satisfying the condition of the current time NOW−Δt≤the flow start time 61<the current time NOW and stores the detected flow statistical records 51 to the event collection buffer 30.

At the next Step 1902, the CPU 1020 retrieves the scenario table 20. At the next Step 1903, the CPU 1020 assigns 1 to the scenario entry number i. At the next Step 1904, the CPU 1020 retrieves a scenario entry 21-i corresponding to the scenario entry number i (i=1 to I) from the scenario table 20. The number I represents the total number of the scenario entries 21 and I=N.

At the next Step 1905, the CPU 1020 searches the event collection buffer 30 for flow statistical records 51 satisfying two search conditions of the flow condition 22 for Flow One and the threshold condition 23 for Flow One.

At the next Step 1906, the CPU 1020 assigns a number j (j=1 to J) to each of the flow statistical records 51 satisfying the foregoing search conditions (1905) and stores them to the event collection buffer 30 as Flow One's. The number J is the total number of flow statistical records 51 showing that a Flow One exceeding the threshold has occurred.

At the next Step 1907, the CPU 1020 searches the event collection buffer 30 for flow statistical records 51 satisfying two search conditions of the flow condition 24 for Flow Two and the threshold condition 25 for Flow Two.

At the next Step 1908, the CPU 1020 assigns a number k (k=1 to K) to each of the flow statistical records 51 satisfying the foregoing search conditions (1907) and stores them to the event collection buffer 30 as Flow Two's. The number K is the total number of flow statistical records 51 showing that a Flow Two exceeding the threshold has occurred.

Through the foregoing processing, flow statistical records 51 showing that the Flow One (event 1) of the scenario entry 21-i exceeding its threshold has occurred and flow statistical records 51 showing that the Flow Two (event 2) of the scenario entry 21-i exceeding its threshold has occurred are assigned the number j and the number k, respectively, and stored to the event collection buffer 30.

At the next Step 1909, the CPU 1020 assigns 1 to the flow statistical record number j.

At the next Step 1910 in FIG. 7B, assuming that the flow statistical record of number j is a Flow One, the CPU 1020 extracts flow statistical records 51 satisfying the condition 26 on the flow relation between Flow One and Flow Two and the condition 27 on the time relation between Flow One and Flow Two from the flow statistical records 51 detected as Flow Two's.

That is to say, the CPU 1020 searches the records of Flow Two's stored in the event collection buffer 30 for records satisfying the condition 26 on the flow relation and the condition 27 on the time relation, in relation to the Flow One of number j.

At the next Step 1911, the CPU 1020 assigns a number 1 (1=1 to L) to each of the flow statistical records 51 satisfying the foregoing search conditions (1910) and stores them to the event collection buffer 30 as Flow Two's in relation to the flow statistical record j of a Flow One. The number L is the total number of records satisfying the conditions 26 on the flow relation between Flow One and Flow Two and the condition 27 on the time relation between Flow One and Flow Two in relation to the flow statistical record 51 assigned the number j.

At the next Step 1912, the CPU 1020 determines that a network anomaly is detected with each combination of the flow statistical record 51 of number j of a Flow One and the flow statistical record 51 of number 1 of a Flow Two.

That is to say, the CPU 1020 determines that, in the flow statistical records 51 in the event collection buffer 30, the combination of the flow statistical record 51 of number j that has exceeded the threshold for Flow One (event 1) and the flow statistical record 51 of number 1 that has exceeded the threshold for Flow Two (event 2) and further satisfies the search conditions on the correlation between Flow One and Flow Two of the foregoing Step 1910 corresponds to an anomaly defined as the scenario entry 21 of number i.

When the CPU 1020 detects an anomaly, the CPU 1020 outputs the anomaly of the scenario entry 21 of number i to the display terminal 130 and creates a SYSLOG 71. Alternatively, the CPU 1020 may hold the scenario entry 21 of number i with which an anomaly is detected and the flow statistical records 51 of numbers j and 1 in the memory 1021 and output the report of the anomaly to the display terminal 130 after completion of the processing in FIGS. 7A and 7B.

Next, at Step 1913, the CPU 1020 determines whether the number j is smaller than the maximum value J. If the determination at Step 1913 is YES, the CPU 1020 adds 1 to the number j at the next Step 1914, returns to Step 1910, and repeats the above-described processing.

If the determination at Step 1913 is NO, the CPU 1020 determines whether the number i of the scenario entry 21 is smaller than I at Step 1915. If the determination at Step 1915 is YES, the CPU 1020 proceeds to the next Step 1916, adds 1 to the number i, returns to the previous Step 1904, and repeats the above-described processing. If the determination at Step 1915 is NO, processing on all scenario entries 21 has been completed and therefore, the CPU 1020 exits the program 40.

Through the above-described processing, the network anomaly detection apparatus 100 can determine whether a plurality of events defined in each scenario entry 21 in the scenario table 20 have sequentially occurred in the flow statistical records 51 stored in the flow statistics DB 50.

Hence, the network anomaly detection apparatus 100 can detect events each concerning a different flow in chronological order and unfailingly detect an anomaly where detected events concerning different flows occur in a specific order.

The network anomaly detection apparatus 100 can detect an anomaly or a sign of an anomaly in the monitoring target network 200 by defining some steps of a cyber kill chain of Reconnaissance, Weaponization, Delivery, Exploitation, Installation, Command and Control (C & C), or Actions on Objective as a scenario entry 21.

In Embodiment 1, the network anomaly detection apparatus 100 selects flow statistical records 51 satisfying the flow condition 22 and the threshold condition 23 as Flow One's for each scenario entry 21, assigns them a number j, and stores them to the event collection buffer 30. Furthermore, the network anomaly detection apparatus 100 selects flow statistical records 51 satisfying the flow condition 24 and the threshold condition 25 as Flow Two's, assigns them a number k, and stores them to the event collection buffer 30.

The network anomaly detection apparatus 100 checks for an anomaly by determining whether any Flow Two satisfying the condition 26 on the flow relation and the condition 27 on the time relation exists, in relation to the flow statistical record 51 of number j of a Flow One.

That is to say, after detecting flow statistical records 51 satisfying the flow condition 22 and the threshold condition 23 as Flow One's, the network anomaly detection apparatus 100 detects flow statistical records 51 satisfying the flow condition 24 and the threshold condition 25 as Flow Two's. The network anomaly detection apparatus 100 then determines that the pair of a Flow One and a Flow Two satisfying the condition 26 on the flow relation and the condition 27 on the time relation are the flows with which an anomaly is detected.

Although Embodiment 1 provides an example where two events of Flow One and Flow Two are defined in a scenario table 20, three or more events (Flows) can be defined in the scenario table 20 to detect an anomaly having complicated steps.

Another algorithm to determine an anomaly in the network 200 to be monitored can be configured to reversely traces the time order. The CPU 1020 determines whether any flow exists that satisfies the flow condition 24 for Flow Two and the threshold condition 25 for Flow Two, stores the flows satisfying the flow conditions 24 for Flow Two and the threshold condition 25 for Flow Two to the event collection buffer 30 as Flow Two's.

The CPU 1020 further determines whether any Flow One exists that satisfies the flow condition 22 for Flow One, the threshold condition 23 for Flow One, and the condition 26 on the flow relation between Flow One and Flow Two, determines whether each of the detected Flow One's satisfies the condition 27 on the time relation between Flow One and Flow Two, and registers the flows satisfying all conditions to the event collection buffer 30 as Flow One's.

This network anomaly detection algorithm that determines Flow One's and Flow Two's while reversely tracing their time order can also detect an anomaly in the network 200 with a combination of a Flow One and a Flow Two registered in the event collection buffer 30.

The Flow One and the Flow Two determined to be a network anomaly are displayed on the display terminal 130, so that the operation administrator of the network anomaly detection apparatus 100 perceives the flows based on which a network anomaly is detected.

Furthermore, the Flow One and the Flow Two determined to be a network anomaly are recorded in a SYSLOG and sent to the visualization server 120, so that the operation administrator of the network anomaly detection system perceives the flows with which a network anomaly is detected.

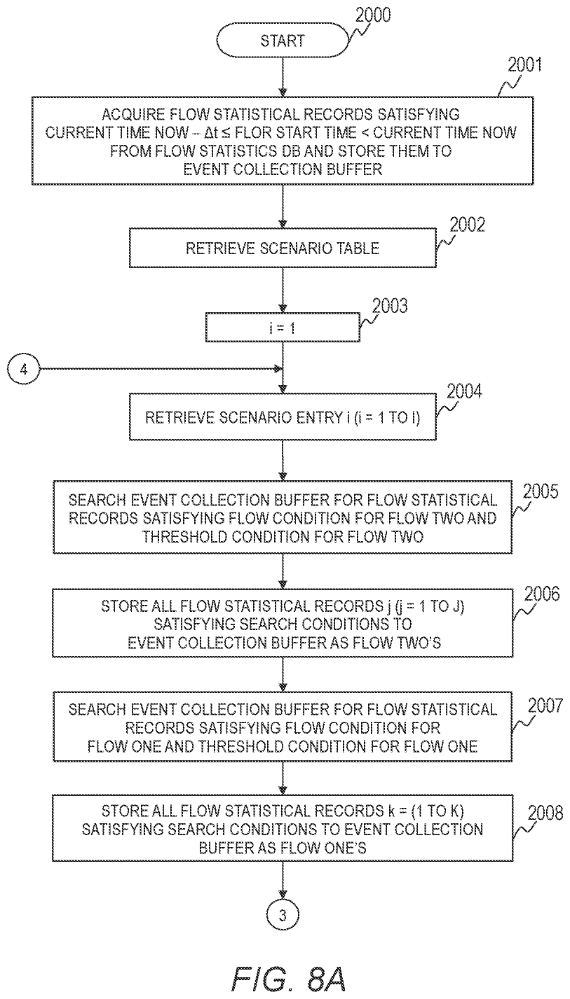

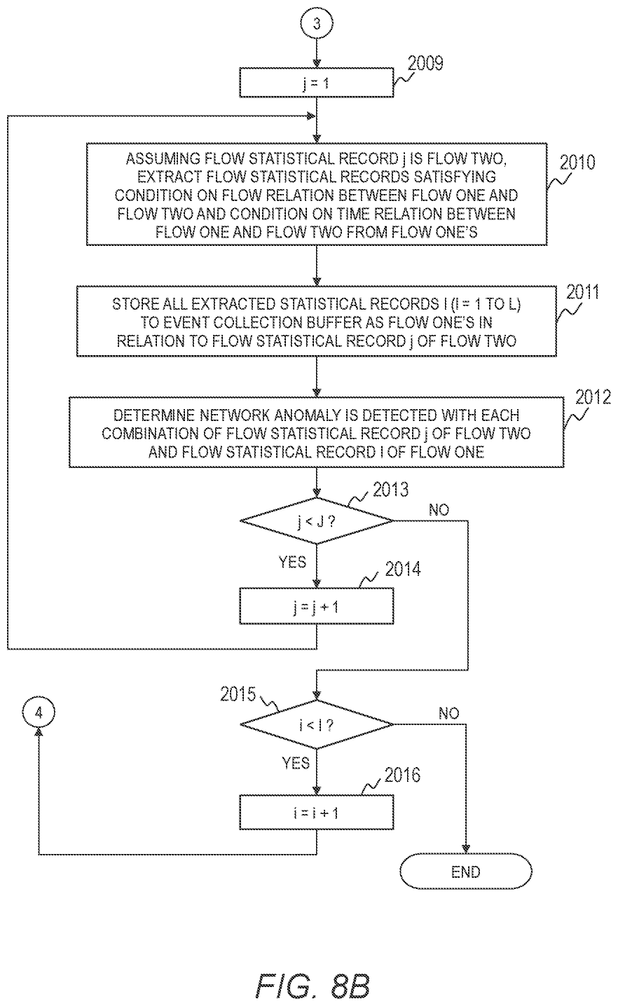

A modified example of the processing of the anomaly detection program 40 to be executed by the CPU 1020 is illustrated in the flowchart of FIGS. 8A and 8B. The flowchart of FIGS. 8A and 8B illustrates the processing to determine a Flow One and a Flow Two while reversely tracing their time order as described above; the remaining is the same as the above-described flowchart of FIGS. 7A and 7B.

At Step 2000, the CPU 1020 starts processing at every predetermined time interval of Δt. At the next Step 2001, the CPU 1020 searches the flow statistics DB 50 for flow statistical records 51 satisfying the condition of the current time NOW−Δt≤the flow start time 61<the current time NOW and stores the detected flow statistical records 51 to the event collection buffer 30.

At the subsequent Steps 2002 to 2004, the CPU 1020 retrieves the scenario table 20, assigns 1 to the scenario entry number i, and retrieves a scenario entry 21-i corresponding to the scenario entry number i (i=1 to I) from the scenario table 20.

At the next Step 2005, the CPU 1020 searches the event collection buffer 30 for flow statistical records 51 satisfying the flow condition 24 for Flow Two and the threshold condition 25 for Flow Two.

At the next Step 2006, the CPU 1020 assigns a number j (j=1 to J) to each of the flow statistical records 51 satisfying the foregoing search conditions (2005) and stores them to the event collection buffer 30 as Flow Two's. The number J is the total number of flow statistical records 51 showing that a Flow Two exceeding the threshold has occurred.

At the next Step 2007, the CPU 1020 searches the event collection buffer 30 for flow statistical records 51 satisfying two search conditions of the flow condition 22 for Flow One and the threshold condition 23 for Flow One.

At the next Step 2008, the CPU 1020 assigns a number k (k=1 to K) to each of the flow statistical records 51 satisfying the foregoing search conditions (2007) and stores them to the event collection buffer 30 as Flow One's. The number K is the total number of flow statistical records 51 showing that a Flow One exceeding the threshold has occurred.

At the next Step 2009 in FIG. 8B, the CPU 1020 assigns 1 to the flow statistical record number j.

At the next Step 2010, assuming that the flow statistical record of number j is a Flow Two, the CPU 1020 extracts flow statistical records 51 satisfying the condition 26 on the flow relation between Flow One and Flow Two and the condition 27 on the time relation between Flow One and Flow Two from the flow statistical records 51 detected as Flow One's.

At the next Step 2011, the CPU 1020 assigns a number 1 (1=1 to L) to each of the flow statistical records 51 satisfying the foregoing search conditions (2010) and stores them to the event collection buffer 30 as Flow One's in relation to the flow statistical record j of a Flow Two. The number L is the total number of records satisfying the condition 26 on the flow relation between Flow One and Flow Two and the condition 27 on the time relation between Flow One and Flow Two in relation to the flow statistical record 51 assigned the number j.

At the next Step 2012, the CPU 1020 determines that a network anomaly is detected with each combination of the flow statistical record 51 of number j of a Flow Two and the flow statistical record 51 of number 1 of a Flow One. This processing is the same as the processing at Step 1912 in FIG. 7B.

Next, at Step 2013, the CPU 1020 determines whether the number j is smaller than the maximum value J. If the determination at Step 2013 is YES, the CPU 1020 adds 1 to the number j at the next Step 2014, returns to Step 2010, and repeats the above-described processing.

If the determination at Step 2013 is NO, the CPU 1020 determines whether the number i of the scenario entry 21 is smaller than I at Step 2015. If the determination at Step 2015 is YES, the CPU 1020 proceeds to the next Step 2016, adds 1 to the number i, returns to the previous Step 2004, and repeats the above-described processing. If the determination at Step 2015 is NO, processing on all scenario entries 21 has been completed and therefore, the CPU 1020 exits the program 40.

The information in the flow statistical records 51 to be stored to the event collection buffer 30 can be limited to information necessary for the CPU 1020 to make determination about the scenario entries 21. As a result, the amount of information in the flow statistical records 51 to be retrieved from the flow statistics DB 50 and the capacity of the event collection buffer 30 can be reduced, achieving speed-up of anomaly detection and load reduction.

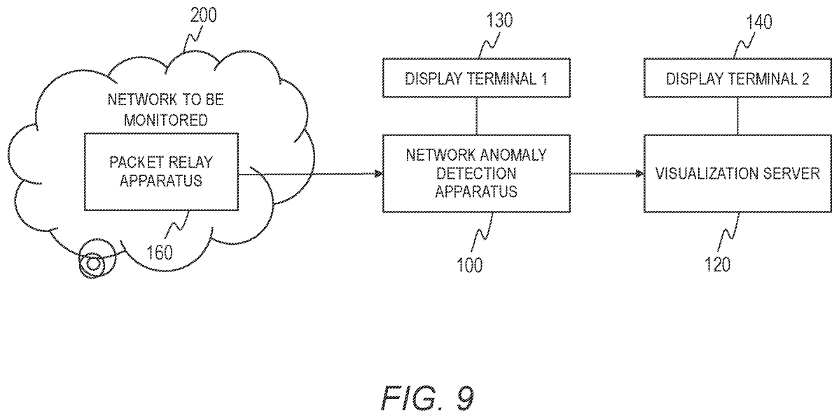

FIG. 9 is a block diagram of a network anomaly detection system including a network anomaly detection apparatus 100 to illustrate a modification of Embodiment 1. In the network 200 to be monitored in this modification, the packet relay apparatus 160 has a function to take flow statistics. The packet relay apparatus 160 collects traffic information in the network 200, generates flow statistical information, and send it to the network anomaly detection apparatus 100.

The packet relay apparatus 160 can use NetFlow according to RFC3954 provided as Non-Patent Document 2 to acquire flow statistical information. The network anomaly detection apparatus 100 performs the same processing as the network anomaly detection apparatus 100 in FIG. 1.

That is to say, the network anomaly detection apparatus 100 analyzes whether any anomaly occurs in the network 200 based on the flow statistical information received from the packet relay apparatus 160, and if it detects a network anomaly, it displays information on a detected network anomaly on the display terminal 130 connected therewith.

The network anomaly detection apparatus 100 further sends the information on the detected network anomaly to a visualization server 120 as a SYSLOG. The visualization server 120 is connectable to other security apparatuses and therefore, it can display information about the network anomaly detected by the network anomaly detection apparatus 100 in association with information on the communication traffic or information on incidents acquired by other apparatuses.

As a result, the location of the network anomaly detected by the network anomaly detection apparatus 100 and information on the communication traffic and incidents before and after the occurrence of the network anomaly can be displayed on the display terminal 130, allowing information about the network anomaly to be displayed from more perspectives.

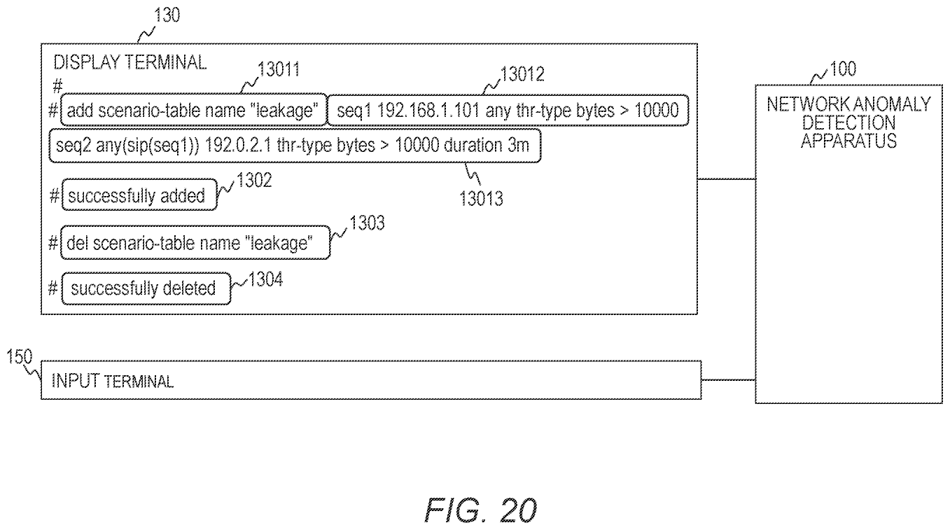

FIG. 20 illustrates an example of a user interface for editing (adding or deleting) a scenario entry 21 in the scenario table 20.

When the operation administrator of the network anomaly detection apparatus 100 inputs commands to add or delete a scenario entry 21 through the input terminal 150, the CPU 1020 receives the commands and displays the addition commands 13011 to 13013 and the result 1302 of the addition commands or the deletion command 1303 and the result 1304 of the deletion command. The signs “#” on the screen of the display terminal 130 are command prompts.

The addition commands include commands 13011, 13012, and 13013. The command 13011 specifies that a scenario entry 21 named “leakage” is to be added to the scenario table 20. The command 13012 specifies that the flow conditions for the first event (seq1) of “leakage” are the source IP address is 192.168.1.101 and the destination IP address is any and the threshold condition is the number of bytes (bytes) of a threshold type (thr-type) is over 10000. The command 13013 specifies that the flow conditions for the second event (seq2) of “leakage” is the source IP address is any IP address detected from seq1 (any(sip(seq1))) and the destination IP address is 192.0.2.1 and the threshold conditions are the number of bytes (bytes) of a threshold type is over 10000 and the time from occurrence of the first event to occurrence of the second event (duration) is not more than 3 minutes (3 m).

For the flow condition 22 for Flow One and the flow condition 24 for Flow Two to be included in a command, the following conditions can be provided by way of example: the IP version 53 is a specific value, one or both of the source IP address 54 and the destination IP address 55 is a specific value or a value in a specific range, the protocol 56 is a specific value, and one or both of the source port number 57 and the destination port number 58 is a specific value or a value in a specific range.

For the threshold condition 23 for Flow One and the threshold condition 25 for Flow Two, the following examples can be provided: the number of packets 59 is not less than or not more than a specific value, the number of bytes 60 is not less than or not more than a specific value, the number of packets per unit time (packet rate) is not less than or not more than a specific value, the number of bytes per unit time (byte rate) is not less than or not more than a specific value, the number of destination IP addresses 55 in a plurality of flow statistical records 51 including a specific source IP address 54 (hereinafter, referred to as the number of different destination IP addresses) is not more than or not less than a specific value, the number of source IP addresses 54 in a plurality of flow statistical records 51 including a specific destination IP address 55 (hereinafter, referred to as the number of different source IP addresses) is not more than or not less than a specific value.

For the condition 26 on the flow relation between Flow One and Flow Two, the following examples can be provided: the source IP address 54 is common to Flow One and Flow Two, the destination IP address 55 is common to Flow One and Flow Two, the destination IP address 55 of Flow One is the same as the source IP address 54 of Flow Two, and the source IP address 54 of Flow One is the same as the destination IP address 55 of Flow Two.

For the condition 27 on the time relation between Flow One and Flow Two, the following examples can be provided: the flow start time 61 of Flow Two is later than the flow start time 61 of Flow One, the flow start time 61 of Flow Two is earlier than the flow start time 61 of Flow One, the flow start time 61 of Flow Two is within a specific time window after the flow start time of Flow One, and the flow start time 61 of Flow Two is within a specific time window before the flow start time of Flow One.

Upon detection of an anomaly in the network 200, the CPU 1020 creates a SYSLOG 71 including information on the flows with which the anomaly is detected and stores the created SYSLOG 71 to the SYSLOG DB 70.

The CPU 1020 retrieves the SYSLOG DB 70 at every predetermined time interval Δt or at a time specified by the operation administrator of the network anomaly detection apparatus 100 and if some SYSLOG 71 exists that has not been sent to the external, sends the unsent SYSLOG 71 to the packet transfer unit 101 via the connection interface 103.

The connection interface 103 notifies the CPU 1010 of the receipt of the SYSLOG 71. The CPU 1010 encapsulates the SYSLOG 71 into IP packets and stores them to the packet buffer 1030 in the memory 1011. The packet sending and receiving unit 1012 transforms them to Ether frames and sends them out.

As described above, the network anomaly detection apparatus 100 in Embodiment 1 detects events each concerning a different flow in chronological order and further, unfailingly detects an anomaly or a sign of an anomaly of a monitoring target network 200 where detected events concerning different flows occur in a specific order.

Embodiment 1 has provided a configuration such that the network anomaly detection apparatus 100 includes the packet transfer unit 101 and the network anomaly detection unit 102 separately; however, the packet transfer unit 101 and the network anomaly detection unit 102 can be unified. In that case, the packet sending and receiving unit 1012 and the packet buffer 1030 are incorporated in the network anomaly detection unit 102.

Embodiment 1 has provided an example where the anomaly detection program 40 extracts the latest flow statistical records 51 from the flow statistics DB 50 at every predetermined time interval to detect an anomaly in the network 200; however, the anomaly detection program 40 can detect an anomaly from the flow statistical records 51 in the period specified by the user of the network anomaly detection apparatus 100.

Embodiment 1 has provided an example where the anomaly detection program 40 outputs information indicating occurrence of an anomaly in the network 200 to the visualization server 120 in the form of SYSLOG; however, the anomaly detection program 40 can be configured to output a log message to the external, instead of a SYSLOG.

### Embodiment 2

Embodiment 2 of this invention describes an example of detecting information leakage with the network anomaly detection apparatus 100 of this invention.

FIG. 10 is a block diagram illustrating an example of the configuration of a network anomaly detection system that allows detection of information leakage with the network anomaly detection apparatus 100 of this invention.

The network 200 to be monitored includes a terminal 210 infected with malware, a file server 220, a switch 230 connecting the infected terminal 210 and the file server 220, a mirror port 231 that mirrors communication relayed by the switch 230, and a router 240 connected with the switch 230. A C & C server 400 managed by the attacker who tries to steal information is connected from outside of the network 200 and issues commands for the infected terminal 210 to manipulate the infected terminal 210.

Communication of the infected terminal 210 when taking a file including classified information from the file server 200 and leaking the information to the attacker's C & C server 400 is described. As prerequisite conditions, the terminal 210 is infected with malware; the attacker can manipulate the infected terminal 210 through the C & C server 400; and the attacker knows the network configuration of the network 200 and the server configuration by operating the infected terminal 210.

The infected terminal 210 downloads the classified information file from the file server 200. The infected terminal 210 sends the downloaded classified information file to the C & C server 400 to leak the classified information file to the attacker.

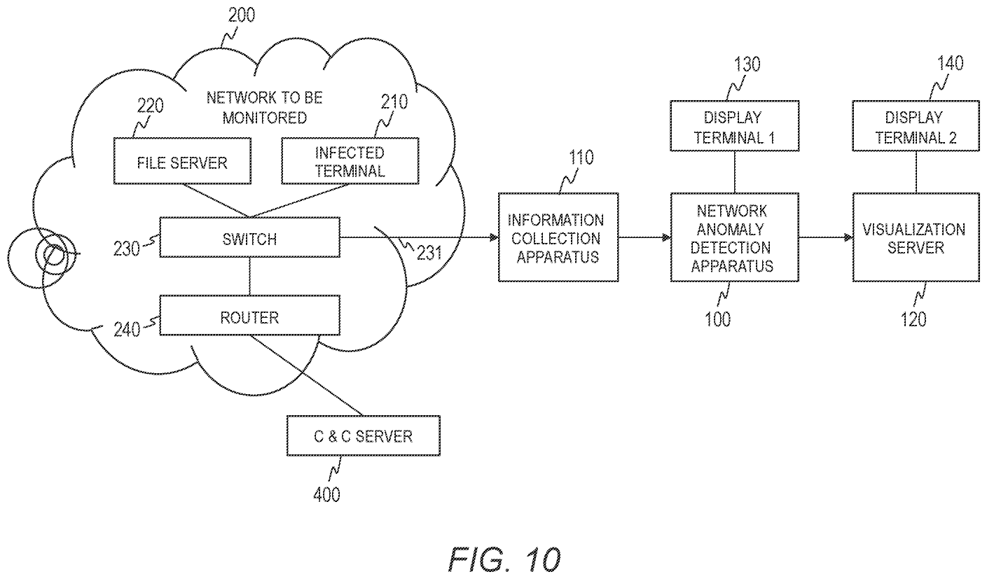

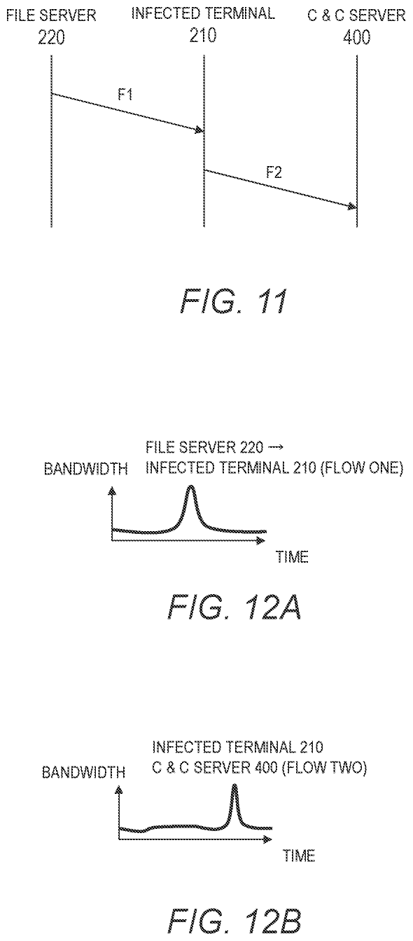

FIG. 11 is a sequence diagram illustrating an example of the flows occurring sequentially in the network 200 when the above-described information leakage occurs.

When the above-described information leakage occurs, communication for the infected terminal 210 to receive the classified information file from the file server 220 starts first (F1). Subsequently, communication of the infected terminal 210 to send the classified information file to the external C & C server 400 starts (F2).

The conditions on the time relation between these flows for information leakage includes an event that a Flow One (F1 in FIG. 11) having a source IP address of the file server 220 and a destination IP address of the infected terminal 210 occurs and thereafter, a Flow Two (F2 in FIG. 11) having a source IP address of the infected terminal 210 and a destination IP address of the C & C server 400 occurs.

The conditions on the flow relation between those flows for information leakage includes an event that the destination IP address of the Flow One is the same as the source IP address of the Flow Two.

The flow conditions 22 for Flow One are to be the source IP address=the IP address of the file server 220 (which can be generalized as the monitoring target IP address as potential information leakage source) and the destination IP address=any because the IP address of the infected terminal to be the destination IP address is unknown. When choosing not specifying the IP address presumed to be the information leakage source, the source IP address can be any.

The flow conditions 24 for Flow Two are to be the source IP address=any because the IP address of the infected terminal to be the source IP address is unknown and the destination IP address=any because the IP address of the C & C server to be the destination IP address is unknown.

The unknown IP address of the C & C server 400 can be replaced with the IP addresses registered in an address list of known C & C servers 400. If such an address list of known C & C servers 400 exists, the destination address of Flow Two for a known C & C server 400 can be specified.

As for the information leakage detection algorithm in Embodiment 2, the modification described in Embodiment 1 that reversely traces the time order in making determination enables reduction in flow statistical records 51 to be examined, compared to the algorithm illustrated in FIGS. 7A and 7B in Embodiment 1. Hence, the information leakage detection can be performed with reduced load, achieving higher efficiency and speed-up.

Embodiment 2 provides an example where an information leakage detection algorithm obtained by combining Algorithm 1 (FIGS. 7A and 7B) and Algorithm 2 (FIGS. 8A and 8B) in Embodiment 1 is executed in the anomaly detection program 40 of the network anomaly detection apparatus 100.

The network anomaly detection apparatus 100 makes determination with the aforementioned Algorithm 2 in the case of using the address list of existing C & C servers 400 and with the aforementioned Algorithm 1 to detect information leakage to an unknown C & C server to efficiently address both the unknown C & C server and the known C & C servers. The information leakage detection algorithm will be described in detail after a scenario entry 21 in the scenario table for detecting information leakage is described.

The threshold condition for Flow One is to be the number of bytes of Flow One>the number of bytes of the classified information file and the threshold condition for Flow Two is to be the number of bytes of Flow Two>the number of bytes of the classified information file. The thresholds can be in number of packets, byte rate, or packet rate as necessary.

The time window to count the number of bytes as a detected parameter to be compared with the threshold is to be changeable by the operating administrator of the network anomaly detection apparatus 100 through adjustment of the time window of the flow start time 61 to be a detected parameter.

If the threshold is so low that flows not leaking information are erroneously detected, raising the threshold can reduce the erroneous detection. Contrarily, if the threshold is too high to detect information leakage, lowering the threshold can cope with the problem. To determine a threshold appropriate to detect information leakage, it is necessary for the operation administrator of the network anomaly detection apparatus 100 to monitor and study the detected parameter such as the number of bytes, the number of packets, the byte rate, or the packet rate in the normal state where no network anomaly occurs, before launching the operation of the network anomaly detection apparatus 100.

After these conditions are specified in the scenario table 20, the CPU 1020 can detect information leakage by determining whether any flow statistical record 51 matching the conditions specified in the scenario table 20 exists in the flow statistical records 51 retrieved from the flow statistics DB 50 and stored in the event collection buffer 30 with reference to the scenario table 20.

FIGS. 12A and 12B are graphs showing examples of bandwidth variation in a network caused by Flow One and Flow Two when information leakage occurs. The peaks of Flow One and Flow Two correspond to the number of bytes of a classified information file and the peak of Flow One (FIG. 12A) occurs earlier than the peak of Flow Two (FIG. 12B).

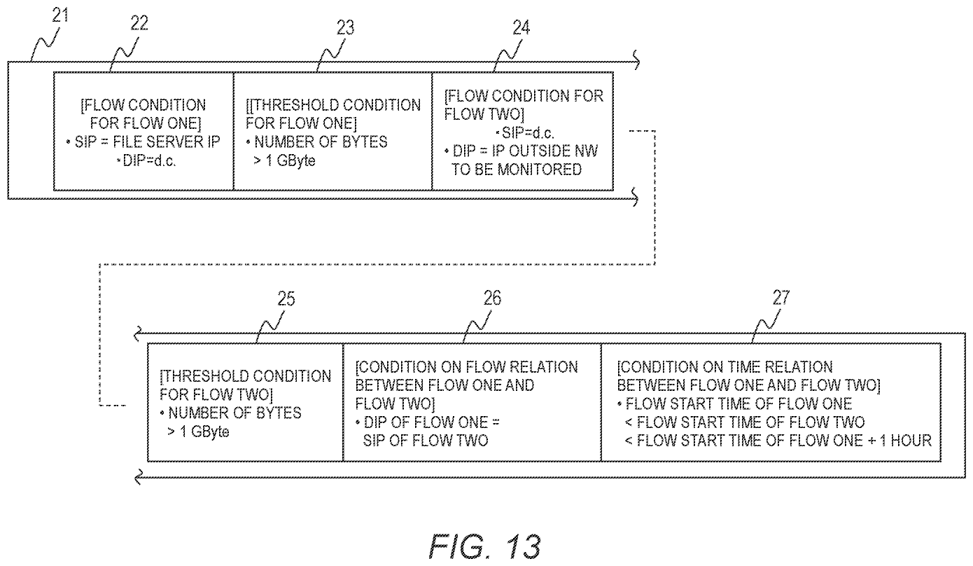

FIG. 13 illustrates an example of a scenario entry 21 in the scenario table 20 for information leakage detection.

The scenario entry 21 is configured with the following conditions. The flow conditions 22 for Flow One are the source IP address (hereinafter SIP)=the IP address of the file server and the destination IP address (hereinafter DIP)=d.c. (any).

The threshold condition 23 for Flow One is the number of bytes>1 GByte. The flow conditions 24 for Flow Two are the SIP=any and the DIP=any IP address outside the network 200.

The threshold condition 25 for Flow Two is the number of bytes>1 GByte. The condition 26 on the flow relation between Flow One and Flow Two is the DIP of Flow One=the SIP of Flow Two.

The condition 27 on the time relation between Flow One and Flow Two is the flow start time of Flow One<the flow start time of Flow Two<the flow start time of Flow One+1 hour.

This scenario enables detection of occurrence of Flow One exceeding 1 GByte from the file server 220 to a terminal suspected to be infected at some IP address and occurrence of Flow Two from a source IP address of the destination IP address of Flow One to an IP address outside the network 200 within one hour from the occurrence of Flow One, namely communication suspected to be information leakage.

The unknown IP address outside the network 200 for the DIP of Flow Two can be replaced with the IP addresses registered in the address list of known C & C servers 400.

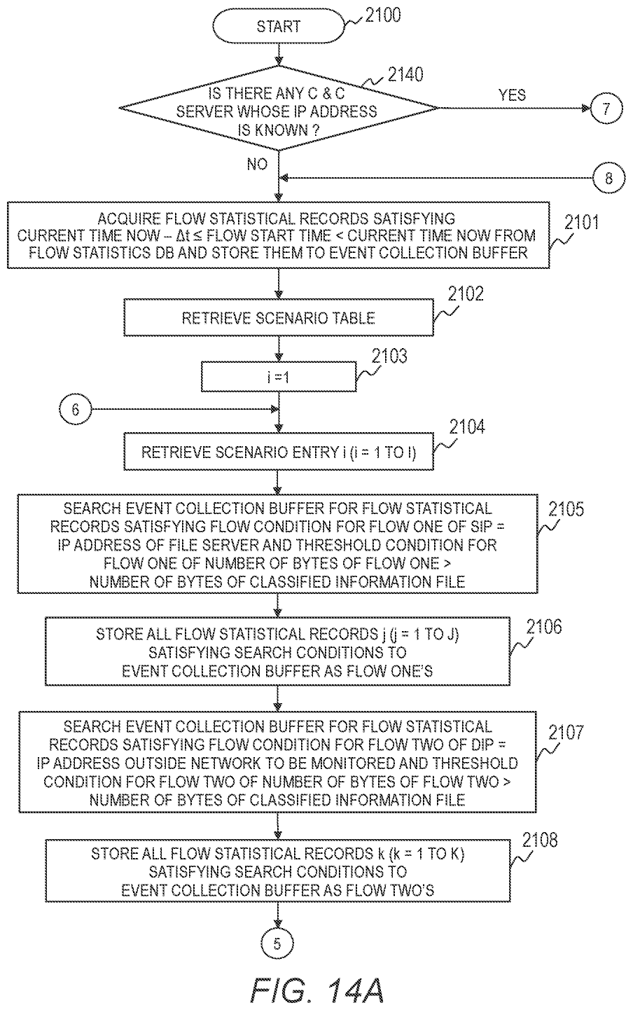

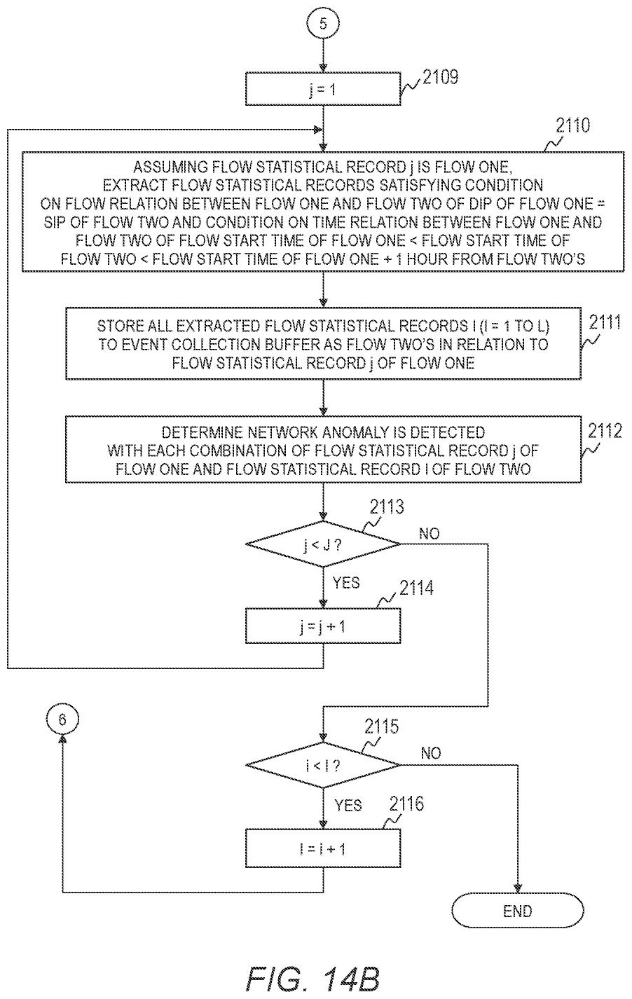

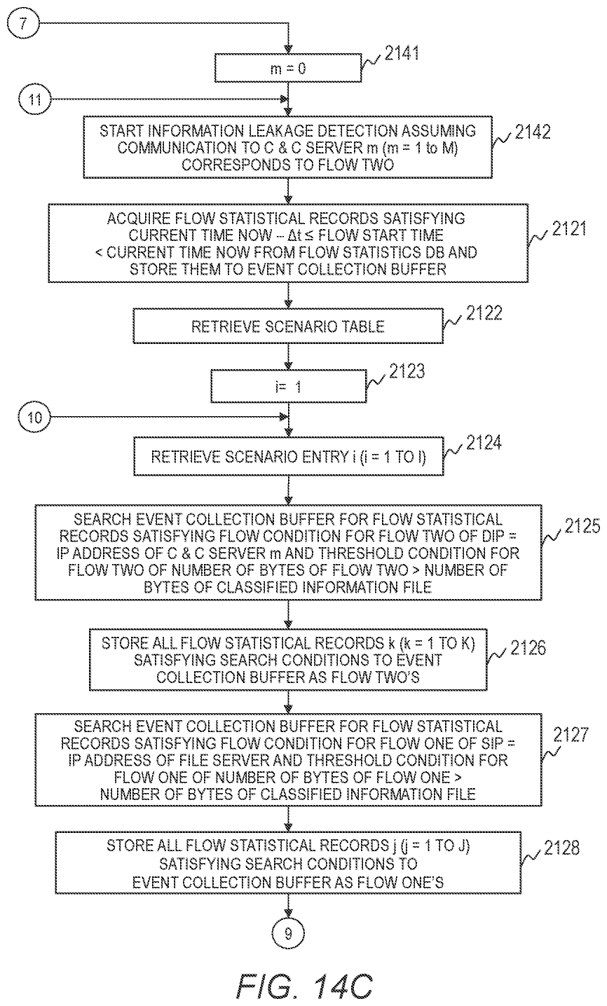

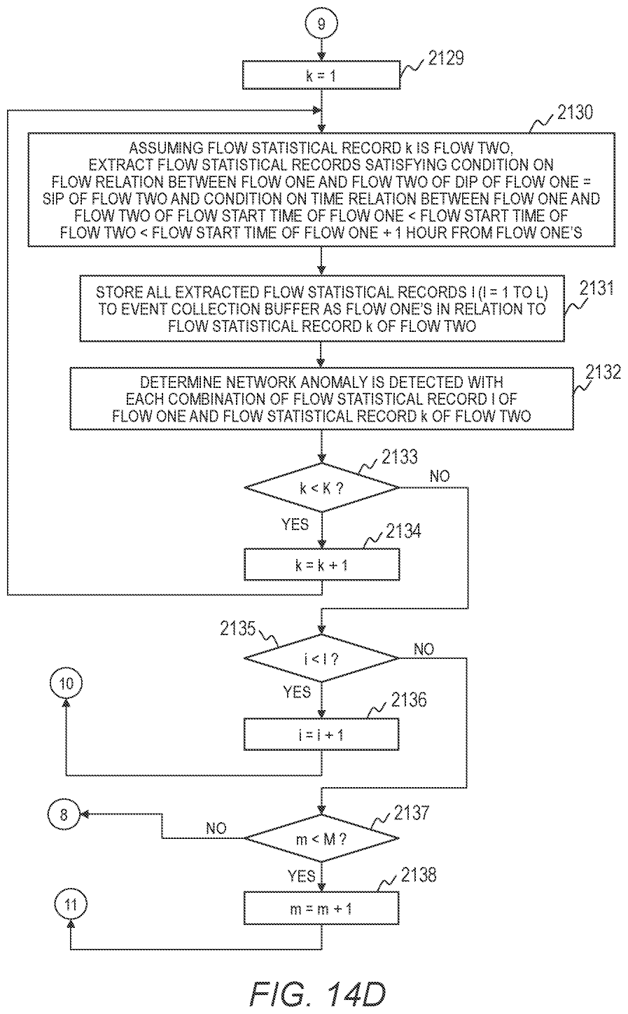

FIGS. 14A to 14D illustrate an information leakage detection algorithm of the anomaly detection program 40 to be executed by the CPU 1020.

At Step 2100, the CPU 1020 starts processing at every predetermined time interval of Δt. At the next Step 2140, the CPU 1020 compares the flow statistic DB 50 with the address list of known C & C servers to determine whether the flow statistical records 51 therein show any C & C server whose IP address is known. Although the address list of known C & C servers 400 is not shown in the drawings, it is stored in advance in the hard disk 1022, for example.

If the determination at Step 2140 is NO, the CPU 1020 proceeds to Step 2101 and if YES, the CPU 1020 proceeds to Step 2141 in FIG. 14C.

At Step 2101 in the case where the flow statistical records 51 do not include any IP address of a known C & C server 400, the CPU 1020 searches the flow statistics DB 50 for flow statistical records 51 satisfying the condition of the current time NOW−Δt≤the flow start time 61<the current time NOW and stores the detected flow statistical records 51 to the event collection buffer 30.

At the subsequent Steps 2102 to 2104, the CPU 1020 retrieves the scenario table 20, assigns 1 to the scenario entry number i, and retrieves a scenario entry 21-i corresponding to the scenario entry number i (i=1 to I) from the scenario table 20.

At the next Step 2105, the CPU 1020 searches the event collection buffer 30 for flow statistical records 51 satisfying the flow condition 22 for Flow One of the SIP=the IP address of the file server 220 and the threshold condition 23 for Flow One of the number of bytes of Flow One>the number of bytes of the classified information file.

At the next Step 2106, the CPU 1020 assigns a number j (j=1 to J) to each of the flow statistical records 51 satisfying the foregoing search conditions (2105) and stores them to the event collection buffer 30 as Flow One's. The number J is the total number of flow statistical records 51 showing that a Flow One exceeding the threshold has occurred.

At the next Step 2107, the CPU 1020 searches the event collection buffer 30 for flow statistical records 51 satisfying the flow condition 24 for Flow Two of the DIP=any IP address outside the network to be monitored and the threshold condition 25 for Flow Two of the number of bytes of Flow Two>the number of bytes of the classified information file.

At the next Step 2108, the CPU 1020 assigns a number k (k=1 to K) to each of the flow statistical records 51 satisfying the foregoing search conditions (2107) and stores them to the event collection buffer 30 as Flow Two's.

At the next Step 2109 in FIG. 14B, the CPU 1020 assigns 1 to the flow statistical record number j.

At the next Step 2110, assuming that the flow statistical record of number j is a Flow One, the CPU 1020 extracts flow statistical records 51 satisfying the condition 26 on the flow relation between Flow One and Flow Two of the DIP of Flow One=the SIP of Flow Two and the condition 27 on the time relation between Flow One and Flow Two of the flow start time of Flow One<the flow start time of Flow Two<the flow start time of Flow One+1 hour from the flow statistical records 51 detected as Flow Two's.

At the next Step 2111, the CPU 1020 assigns a number 1 (1=1 to L) to each of the flow statistical records 51 satisfying the foregoing search conditions (2110) and stores them to the event collection buffer 30 as Flow Two's in relation to the flow statistical record j of a Flow One.

At the next Step 2112, the CPU 1020 determines that a network anomaly is detected with each combination of the flow statistical record 51 of number j of a Flow One and the flow statistical record 51 of number 1 of a Flow Two. This processing is the same as the processing at Step 1912 in FIG. 7B in Embodiment 1.

Next, at Step 2113, the CPU 1020 determines whether the number j is smaller than the maximum value J. If the determination at Step 2113 is YES, the CPU 1020 adds 1 to the number j at the next Step 2114, returns to Step 2110, and repeats the above-described processing.

If the determination at Step 2113 is NO, the CPU 1020 determines whether the number i of the scenario entry 21 is smaller than the maximum value I at Step 2115. If the determination at Step 2115 is YES, the CPU 1020 proceeds to the next Step 2116, adds 1 to the number i, returns to the previous Step 2104 in FIG. 14A, and repeats the above-described processing. If the determination at Step 2115 is NO, processing on all scenario entries 21 has been completed and therefore, the CPU 1020 exits the program 40.

If the determination at Step 2140 in FIG. 14A is YES, the CPU 1020 proceeds to Step 2141 in FIG. 14C and assigns 1 to the number m of a C & C server 400.

At the next Step 2142, the CPU 1020 starts determination on information leakage, assuming that communication to the C & C server of number m (m=1 to M) corresponds to a Flow Two. The number M is the total number (maximum value) of the C & C servers 400 acquired at Step 2140.

At the next Step 2121, the CPU 1020 searches the flow statistics DB 50 for flow statistical records 51 satisfying the condition of the current time NOW−Δt the flow start time 61<the current time NOW and stores the detected flow statistical records 51 to the event collection buffer 30.

At the subsequent Steps 2122 to 2124, the CPU 1020 retrieves the scenario table 20, assigns 1 to the scenario entry number i, and retrieves a scenario entry 21-i corresponding to the scenario entry number i (i=1 to I) from the scenario table 20.

At the next Step 2125, the CPU 1020 searches the event collection buffer 30 for flow statistical records 51 satisfying the flow condition 24 for Flow Two of the DIP=the IP address of the C & C server m and the threshold condition 25 for Flow Two of the number of bytes of Flow Two>the number of bytes of the classified information file.

At the next Step 2126, the CPU 1020 assigns a number k (k=1 to K) to each of the flow statistical records 51 satisfying the foregoing search conditions (2125) and stores them to the event collection buffer 30 as Flow Two's.

At next Step 2127, the CPU 1020 searches the event collection buffer 30 for flow statistical records 51 satisfying the flow condition 22 for Flow One of the SIP=the IP address of the file server 220 and the threshold condition 23 for Flow One of the number of bytes of Flow One>the number of bytes of the classified information file.

At the next Step 2128, the CPU 1020 assigns a number j (j=1 to J) to each of the flow statistical records 51 satisfying the foregoing search conditions (2127) and stores them to the event collection buffer 30 as Flow One's.

At the next Step 2129 in FIG. 14D, the CPU 1020 assigns 1 to the flow statistical record number k.

At the next Step 2130, assuming that the flow statistical record of number k is a Flow Two, the CPU 1020 extracts flow statistical records 51 satisfying the condition 26 on the flow relation between Flow One and Flow Two of the DIP of Flow One=the SIP of Flow Two and the condition 27 on the time relation between Flow One and Flow Two of the flow start time of Flow One<the flow start time of Flow Two<the flow start time of Flow One+1 hour from the flow statistical records 51 detected as Flow One's.

At the next Step 2131, the CPU 1020 assigns a number 1 (1=1 to L) to each of the flow statistical records 51 satisfying the foregoing search conditions (2130) and stores them to the event collection buffer 30 as Flow One's in relation to the flow statistical record k of a Flow Two.

At the next Step 2132, the CPU 1020 determines that a network anomaly is detected with each combination of the flow statistical record 51 of number 1 of a Flow One and the flow statistical record 51 of number k of a Flow Two. This processing is the same as the processing at Step 1912 in FIG. 7B in Embodiment 1.

Next, at Step 2133, the CPU 1020 determines whether the number k is smaller than the maximum value K. If the determination at Step 2133 is YES, the CPU 1020 adds 1 to the number k at the next Step 2134, returns to Step 2130, and repeats the above-described processing.

If the determination at Step 2133 is NO, the CPU 1020 determines whether the number i of the scenario entry 21 is smaller than the maximum value I at Step 2135. If the determination at Step 2135 is YES, the CPU 1020 proceeds to the next Step 2136, adds 1 to the number i, returns to the previous Step 2124 in FIG. 14C, and repeats the above-described processing. If the determination at Step 2135 is NO, the CPU 1020 determines whether the number m of the C & C server 400 is smaller than the maximum value M.

If the determination at Step 2137 is YES, the CPU 1020 proceeds to the next Step 2138, adds 1 to the number m, returns to the previous Step 2142 in FIG. 14C, and repeats the above-described processing. If the determination at Step 2137 is NO, the CPU 1020 proceeds to Step 2101 in FIG. 14A and executes the above-described processing.

As described above, the network anomaly detection apparatus 100 in Embodiment 2 executes Algorithm 1 (FIGS. 7A and 7B) that detects an anomaly in accordance with the sequence from Flow One to Flow Two, like in the foregoing Embodiment 1, if none of the IP addresses of the known C & C servers 400 is included in the flow statistical records 51. However, if one or more of the IP addresses of the known C & C server 400 are included in the flow statistical records 51, the network anomaly detection apparatus 100 executes Algorithm 2 (FIGS. 8A and 8B) that detects an anomaly in accordance with the sequence from Flow Two to Flow One and thereafter, executes Algorithm 1 (FIGS. 7A and 7B).

Through this configuration, the network anomaly detection apparatus 100 can detect events each concerning a different flow in chronological order by examining a reduced number of flow statistical records 51 and unfailingly detect information leakage where detected events concerning different flows occur in a specific order.

### Embodiment 3

Embodiment 3 of this invention describes an example of detecting a botnet with the network anomaly detection apparatus 100 of this invention. The activities of a botnet are described in the aforementioned Non-Patent Documents 5 and 6.

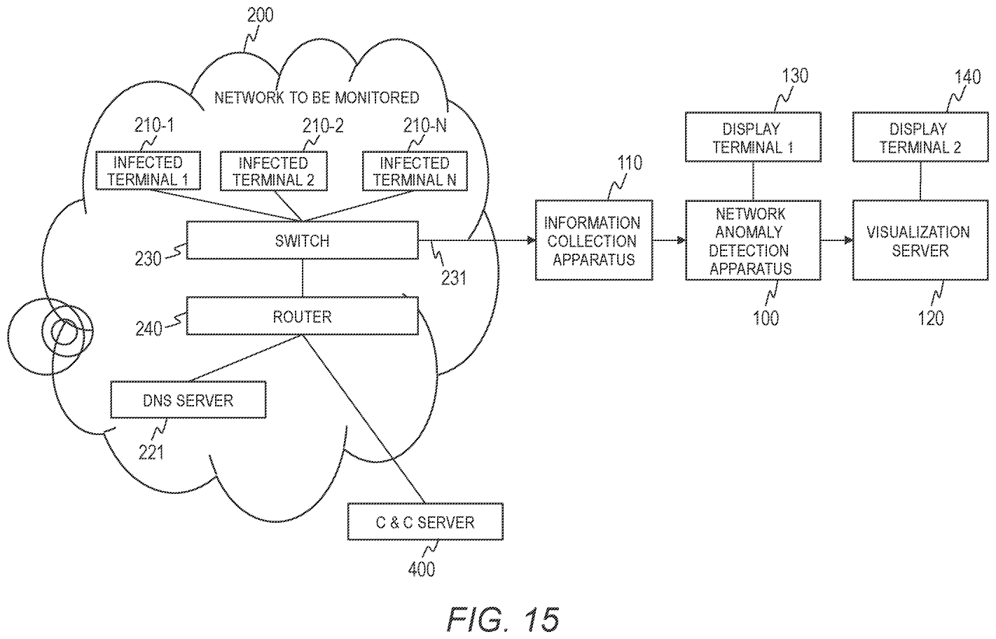

FIG. 15 is a block diagram illustrating an example of the configuration of a network anomaly detection system that allows detection of a botnet with the network anomaly detection apparatus 100 of this invention.

The network 200 to be monitored includes a botnet composed of an infected terminal 1 (210-1), an infected terminal 2 (210-2), and an infected terminal N (210-N), a DNS server 221, a switch 230 connecting the botnet and the DNS server 221, and a router 240. The switch 230 has a mirror port 231 that mirrors communication relayed by the switch 230.

The C & C server 400 managed by the attacker who operates the botnet is connected from outside of the network 200 and issues commands for the infected terminals 210 to manipulate the infected terminals 210.

For the botnet to start attack activity, the infected terminals 1 (210-1) to N (210-N) belonging to the botnet need to establish communication with the C & C server 400 that issues an attack order. Accordingly, the infected terminals 1 (210-1) to N (210-N) first access the DNS server 221 almost at the same time and try to acquire the IP address of the C & C server 400.

Subsequently, the infected terminals 1 (210-1) to N (210-N) of the botnet that have acquired the IP address of the C & C server 400 through the access to the DNS server 221 make communication called callback, which requests an attack order to the C & C server 400.

In the callback communication, the infected terminals 1 (210-1) to N (210-N) of the botnet access the C & C server 400 almost at the same time. Accordingly, if the simultaneous accesses from the botnet to the DNS server 200 and the subsequent simultaneous accesses from the botnet to the C & C server 400 can be detected with the network anomaly detection apparatus 100, detection of communication suspected to be made by a botnet becomes available.

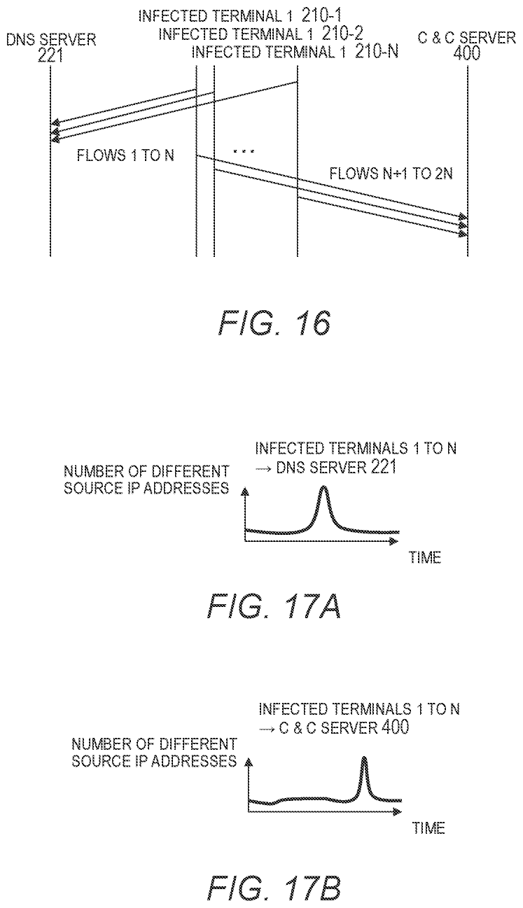

FIG. 16 is a sequence diagram illustrating an example of the flows occurring sequentially in the network 200 when the above-described attack activity of a botnet occurs.

When the above-described attack activity of a botnet starts, first, communication requesting the IP address of the C & C server 400 with the domain name is made from all infected terminals 1 (210-1) to N (210-N) together to the DNS server 221 (Flows 1 to N).

As a result of the accesses to the DNS server 221, the infected terminals 1 (210-1) to N (210-N) acquire the IP address of the C & C server 400. Subsequently, the infected terminals 1 (210-1) to N (210-N) start sending callbacks to the C & C server 400 together (Flows N+1 to 2N).

The condition 27 on the time relation among these flows relevant to a botnet attack includes an event that Flows 1 to N occur from N different source IP addresses 54 of the infected terminals 1 (210-1) to N (210-N) to a destination IP address 55 of the DNS server 221 and thereafter, Flows N+1 to 2N occur from the source IP addresses 54 of the infected terminals 1 (210-1) to N (210-N) to a destination IP address 55 of the C & C server 400.

The condition 26 on the flow relation among the flows relevant to a botnet attack includes an event that N or more of the source IP addresses 54 are common to the Flows 1 to N and the Flows N+1 to 2N. If this condition causes high load to the CPU 1020, this condition can be eliminated from detecting an anomaly and replaced with the condition on the number of different source addresses 54, as will be described later.

The flow conditions 22 for Flows 1 to N are to be that the source IP addresses 54 are any N different IP addresses because the IP addresses of the infected terminals 1 (210-1) to N (210-N) are unknown and that the destination IP addresses 55 are the IP address of the DNS server 221.

The flow conditions 24 for Flows N+1 to 2N are to be that the source IP addresses 54 are any N different IP addresses because the IP addresses of the infected terminals 1 (210-1) to N (210-N) are unknown and that the destination IP addresses 55 are any because the IP address of the C & C server is unknown.

The unknown IP address of the C & C server 400 can be replaced with the IP addresses registered in the address list of known C & C servers 400. If such an address list of known C & C servers 400 exists, the destination addresses of the Flows N+1 to 2N for a known C & C server 400 can be specified.

Accordingly, as for a botnet detection algorithm, Algorithm 2 (FIGS. 8A and 8B) described in Embodiment 1 that reversely traces the time order in making determination enables reduction in flow statistical records 51 to be examined, compared to Algorithm 1 (FIGS. 7A and 7B).

Hence, the botnet detection can be performed with reduced load, achieving higher efficiency and speed-up.

Embodiment 3 employs a botnet detection algorithm obtained by combining Algorithm 1 (FIGS. 7A and 7B) and Algorithm 2 (FIGS. 8A and 8B). This algorithm makes determination on the addresses in the address list of known C & C servers 400 with Algorithm 2 and makes determination based on an assumption that the C & C server is unknown with Algorithm 1 to detect a botnet.

As a result, the network anomaly detection apparatus 100 can efficiently address both the unknown C & C server 400 and the known C & C servers 400. The botnet detection algorithm will be described in detail after a scenario entry 21 in a scenario table 20 for botnet detection is described.

The threshold condition 23 for Flows 1 to N is expressed by the number of source IP addresses 54 of the infected terminals 1 (210-1) to N (210-N) of the Flows 1 to N. Since the number of infected terminals 210 in the network 200 is unknown, let the number of source IP addresses 54 to detect a botnet attack be N; the threshold condition 23 is specified as the number of different source IP addresses 54>N. Instead of the source IP addresses 54, the source MAC addresses can be used; the threshold condition can be the number of source MAC addresses>N.

The time window to count the number of different source IP addresses 54 as a detected parameter to be compared with the threshold is to be changeable by the operation administrator of the network anomaly detection apparatus 100 through adjustment of the time window of the flow start time 61 to be a detected parameter.

If the threshold is so low that normal flows are erroneously detected as attack activity of a botnet, raising the threshold can reduce the erroneous detection. Contrarily, if the threshold is too high to detect a botnet, lowering the threshold can cope with the problem. To determine a threshold appropriate to detect a botnet, it is necessary for the operation administrator of the network anomaly detection apparatus 100 to monitor and study the detected parameter or the number of different source IP addresses 54 in the normal state where no network anomaly occurs, before launching the operation of the network anomaly detection apparatus 100.

After these conditions are specified in the scenario table 20, the CPU 1020 can detect attack activity of a botnet by determining whether any anomaly matching the conditions in the scenario table 20 exists in the flow statistical records 51 retrieved from the flow statistics DB 50 and stored in the event collection buffer 30 with reference to the scenario table 20.

FIG. 17A is a graph showing a relation between the bandwidth (the number of different source IP addresses 54) from a botnet to the DNS server 221 and the time. FIG. 17B is a graph showing a relation between the bandwidth (the number of different source IP addresses 54) from the botnet to the C & C server 400 and the time.

FIGS. 17A and 17B show examples of the variation in the number of different source IP addresses of Flows 1 to N or the flows to the DNS server 221 and Flows N+1 to 2N or the flows to the C & C server 400.

The peaks of the flows to the DNS server 221 and the flows to the C & C server 400 correspond to the number of infected terminals 1 (210-1) to N (210-N) and the peak of the flows to the DNS server 221 occurs earlier than the peak of the flows to the C & C server 400.

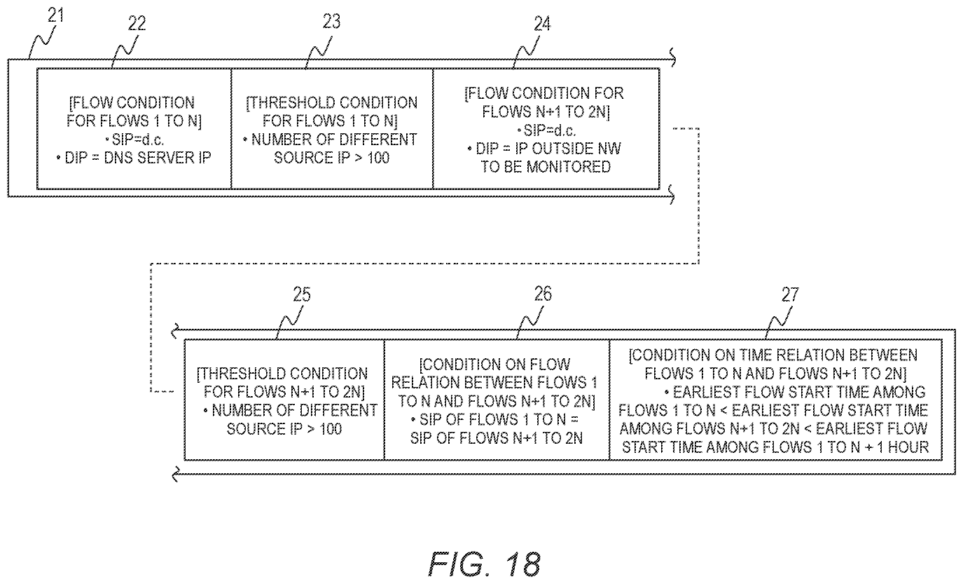

FIG. 18 illustrates an example of a scenario entry 21 in the scenario table 20 for botnet detection. The scenario entry 21 is configured with the following conditions. The flow conditions 22 for Flows 1 to N are the SIP=d.c. (any) and the DIP=the IP address of the DNS server 221. The threshold condition 23 for Flows 1 to N are the number of different source IP addresses>100.

The flow conditions 24 for Flows N+1 to 2N are the SIP=any and the DIP=any IP address outside the network 200. The threshold condition 25 for Flows N+1 to 2N is the number of different source IP addresses>100.

The condition 26 on the flow relation between Flows 1 to N and Flows N+1 to 2N is that N or more source IP addresses are common to the Flows 1 to N and the Flows N+1 to 2N.

The condition 27 on the time relation between Flows 1 to N and Flows N+1 to 2N is the earliest flow start time among Flows 1 to N<the earliest flow start time among Flows N+1 to 2N<the earliest flow start time among Flows 1 to N+1 hour.

This scenario enables detection of occurrence of Flows 1 to N from the infected terminals 1 (210-1) to N (210-N) to the DNS server 221 in which the number of different source IP addresses is more than 100 and occurrence of Flows N+1 to 2N from the source IP addresses of the infected terminals 1 (210-1) to N (210-N) to an IP address outside the network 200 within one hour from the occurrence of Flows 1 to N, namely communication suspected to be attack activity of a botnet.

If the condition 26 on the flow relation between Flows 1 to N and Flows N+1 to 2N causes high load to the CPU 1020, this condition can be eliminated from detecting an anomaly and replaced with the threshold condition 23 for Flows 1 to N and the threshold condition 25 for Flows N+1 to 2N.

The unknown IP address outside the network 200 for the DIP of the Flows N+1 to 2N can be replaced with the IP addresses registered in the address list of known C & C servers 400.

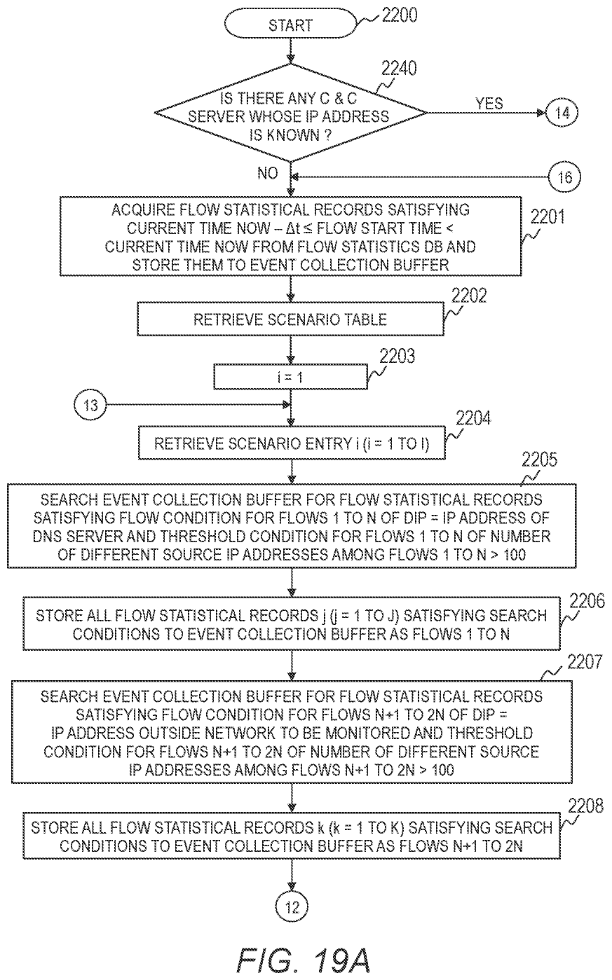

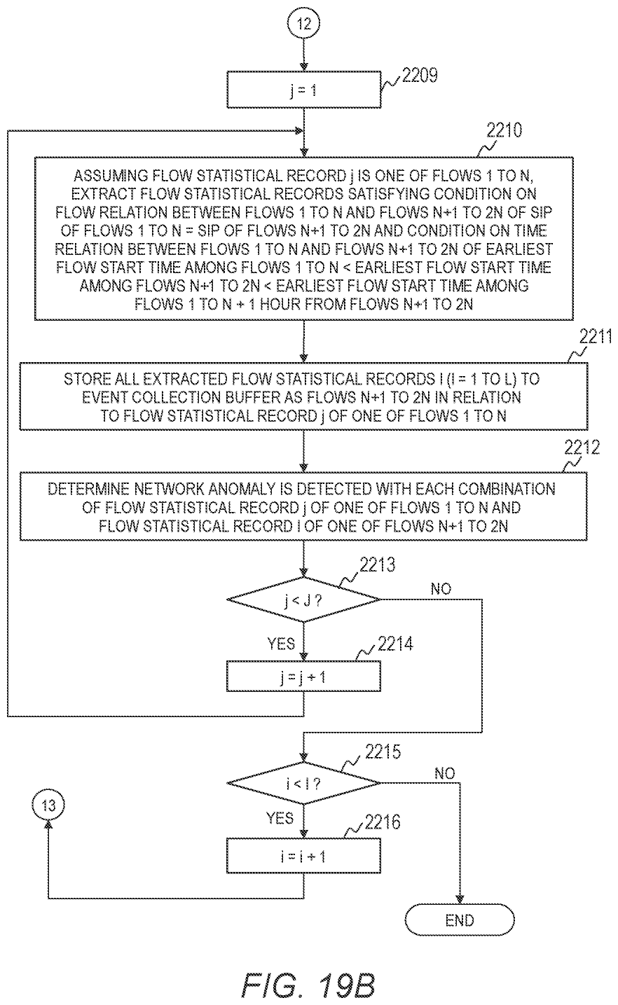

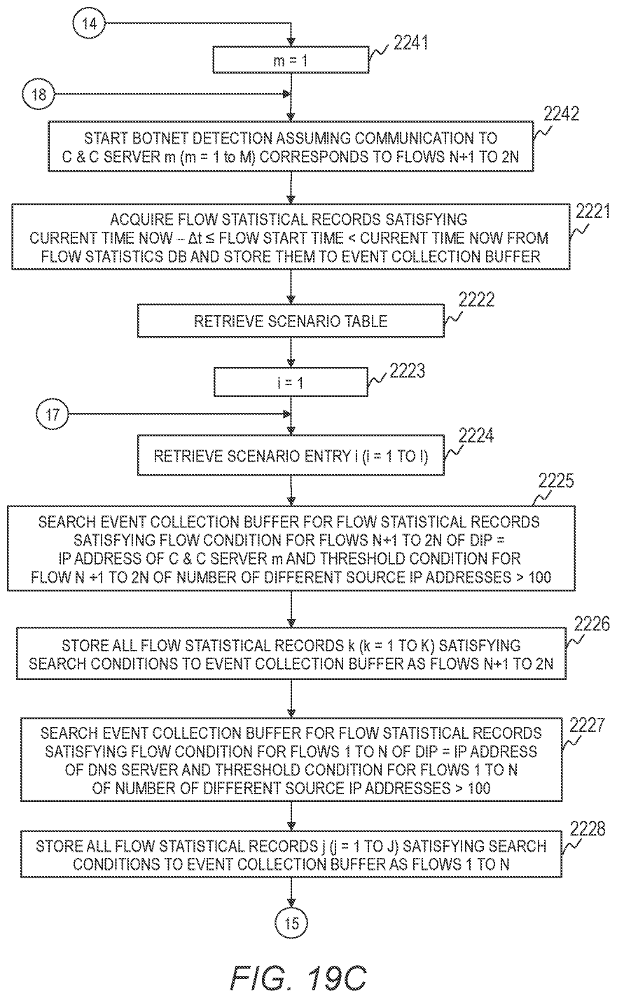

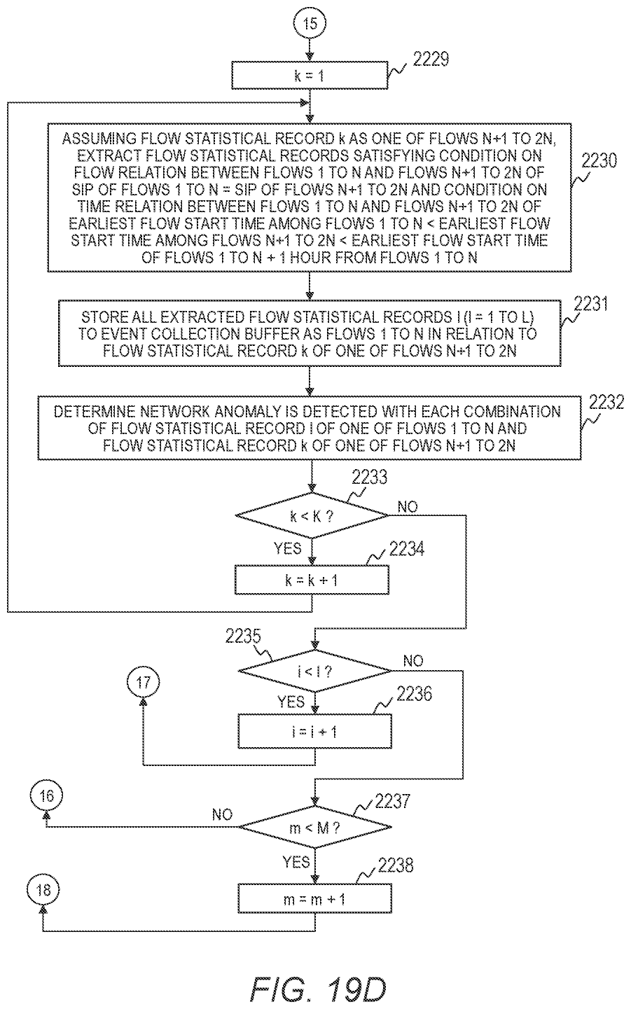

FIGS. 19A to 19D illustrate a botnet detection algorithm of the anomaly detection program 40 to be executed by the CPU 1020.

At Step 2200, the CPU 1020 starts processing at every predetermined time interval of Δt.

At the next Step 2240, the CPU 1020 compares the flow statistic DB 50 with the address list of known C & C servers to determine whether the flow statistical records 51 therein show any C & C server whose IP address is known. Although the address list of known C & C servers 400 is not shown in the drawings, it is stored in advance in the hard disk 1022.

If the determination at Step 2240 is NO, the CPU 1020 proceeds to Step 2201 and if YES, the CPU 1020 proceeds to Step 2241 in FIG. 19C.

At Step 2201 in the case where the flow statistical records 51 do not include any IP address of a known C & C server 400, the CPU 1020 searches the flow statistics DB 50 for flow statistical records 51 satisfying the condition of the current time NOW−Δt≤the flow start time 61<the current time NOW and stores the detected flow statistical records 51 to the event collection buffer 30.

At the subsequent Steps 2202 to 2204, the CPU 1020 retrieves the scenario table 20, assigns 1 to the scenario entry number i, and retrieves a scenario entry 21-i corresponding to the scenario entry number i (i=1 to I) from the scenario table 20.

At the next Step 2205, the CPU 1020 searches the event collection buffer 30 for flow statistical records 51 satisfying the flow condition 22 for Flows 1 to N of the DIP=the IP address of the DNS server and the threshold condition 23 for Flows 1 to N of the number of different source IP addresses among Flows 1 to N>100.

At the next Step 2206, the CPU 1020 assigns a number j (j=1 to J) to each of the flow statistical records 51 satisfying the foregoing search conditions (2205) and stores them to the event collection buffer 30 as Flows 1 to N.

At the next Step 2207, the CPU 1020 searches the event collection buffer 30 for flow statistical records 51 satisfying the flow condition 24 for Flows N+1 to 2N of the DIP=an IP address outside the network 200 to be monitored and the threshold condition 25 for Flows N+1 to 2N of the number of different source IP addresses among Flows N+1 to 2N>100.

At the next Step 2208, the CPU 1020 assigns a number k (k=1 to K) to each of the flow statistical records 51 satisfying the foregoing search conditions (2207) and stores them to the event collection buffer 30 as Flows N+1 to 2N.

At the next Step 2209 in FIG. 19B, the CPU 1020 assigns 1 to the flow statistical record number j.

At the next Step 2210, assuming that the flow statistical record of number j is one of the Flows 1 to N, the CPU 1020 extracts flow statistical records 51 satisfying the condition 26 on the flow relation between Flows 1 to N and Flows N+1 to 2N of the SIP of Flows 1 to N=the SIP of Flows N+1 to 2N and the condition 27 on the time relation between Flows 1 to N and Flows N+1 to 2N of the earliest flow start time among Flows 1 to N<the earliest flow start time among Flows N+1 to 2N<the earliest flow start time among Flows 1 to N+1 hour from the flow statistical records 51 detected as Flows N+1 to 2N.

At the next Step 2211, the CPU 1020 assigns a number 1 (1=1 to L) to each of the flow statistical records 51 satisfying the foregoing search conditions (2210) and stores them to the event collection buffer 30 as Flows N+1 to 2N in relation to the flow statistical record j of one of the Flows 1 to N.

At the next Step 2212, the CPU 1020 determines that a network anomaly is detected with each combination of the flow statistical record 51 of number j of one of the Flows 1 to N and the flow statistical records 51 of number 1 of one of the Flows N+1 to 2N. This processing is the same as the processing at Step 1912 in FIG. 7B in Embodiment 1.

Next, at Step 2213, the CPU 1020 determines whether the number j is smaller than the maximum value J. If the determination at Step 2213 is YES, the CPU 1020 adds 1 to the number j at the next Step 2214, returns to Step 2120, and repeats the above-described processing.

If the determination at Step 2213 is NO, the CPU 1020 determines whether the number i of the scenario entry 21 is smaller than the maximum value I at Step 2215. If the determination at Step 2215 is YES, the CPU 1020 proceeds to the next Step 2216, adds 1 to the number i, returns to the previous Step 2204 in FIG. 19A, and repeats the above-described processing. If the determination at Step 2215 is NO, processing on all scenario entries 21 has been completed and therefore, the CPU 1020 exits the program 40.

If the determination at Step 2240 in FIG. 19A is YES, the CPU 1020 proceeds to Step 2241 in FIG. 19C and assigns 1 to the number m of a C & C server 400.

At the next Step 2242, the CPU 1020 starts determination on botnet, assuming that communication to the C & C server 400 of number m (m=1 to M) corresponds to Flows N+1 to 2N.

At the next Step 2221, the CPU 1020 searches the flow statistics DB 50 for flow statistical records 51 satisfying the condition of the current time NOW−Δt the flow start time 61<the current time NOW and stores the detected flow statistical records 51 to the event collection buffer 30.

At the subsequent Steps 2222 to 2224, the CPU 1020 retrieves the scenario table 20, assigns 1 to the scenario entry number i, and retrieves a scenario entry 21-i corresponding to the scenario entry number i (i=1 to I) from the scenario table 20.

At the next Step 2225, the CPU 1020 searches the event collection buffer 30 for flow statistical records 51 satisfying the flow condition 24 for Flows N+1 to 2N of the DIP=the IP address of the C & C server m and the threshold condition 25 for Flows N+1 to 2N of the number of different source IP addresses of Flow N+1 to 2N>100.

At the next Step 2226, the CPU 1020 assigns a number k (k=1 to K) to each of the flow statistical records 51 satisfying the foregoing search conditions (2205) and stores them to the event collection buffer 30 as Flows N+1 to 2N.

At next Step 2227, the CPU 1020 searches the event collection buffer 30 for flow statistical records 51 satisfying the flow condition 22 for Flows 1 to N of the DIP=the IP address of the DNS server and the threshold condition 23 for Flows 1 to N of the number of different source IP addresses>100.

At the next Step 2228, the CPU 1020 assigns a number j (j=1 to J) to each of the flow statistical records 51 satisfying the foregoing search conditions (2227) and stores them to the event collection buffer 30 as Flows 1 to N.

At the next Step 2229 in FIG. 19D, the CPU 1020 assigns 1 to the flow statistical record number k.

At the next Step 2230, assuming that the flow statistical record of number k is one of the Flows N+1 to 2N, the CPU 1020 extracts flow statistical records 51 satisfying the condition 26 on the flow relation between Flows 1 to N and Flows N+1 to 2N of the SIP of Flows 1 to N=the SIP of Flows N+1 to 2N and the condition 27 on the time relation between Flows 1 to N and Flows N+1 to 2N of the earliest flow start time among Flows 1 to N<the earliest flow start time among Flows N+1 to 2N<the earliest flow start time among Flows 1 to N+1 hour from the flow statistical records 51 detected as Flows 1 to N.

At the next Step 2231, the CPU 1020 assigns a number 1 (1=1 to L) to each of the flow statistical records 51 satisfying the foregoing search conditions (2230) and stores them to the event collection buffer 30 as Flows 1 to N in relation to the flow statistical record k of one of the Flows N+1 to 2N.

At the next Step 2232, the CPU 1020 determines that a network anomaly is detected with each combination of the flow statistical record 51 of number 1 of one of the Flows 1 to N and the flow statistical record 51 of number k of one of the Flows N+1 to 2N. This processing is the same as the processing at Step 1912 in FIG. 7B in Embodiment 1.

Next, at Step 2233, the CPU 1020 determines whether the number k is smaller than the maximum value K. If the determination at Step 2233 is YES, the CPU 1020 adds 1 to the number k at the next Step 2234, returns to Step 2230, and repeats the above-described processing.

If the determination at Step 2233 is NO, the CPU 1020 determines whether the number i of the scenario entry 21 is smaller than the maximum value I at Step 2235. If the determination at Step 2235 is YES, the CPU 1020 proceeds to the next Step 2236, adds 1 to the number i, returns to the previous Step 2224 in FIG. 19C, and repeats the above-described processing.

If the determination at Step 2235 is NO, the CPU 1020 determines whether the number m of the C & C server 400 is smaller than the maximum value M. If the determination at Step 2237 is YES, the CPU 1020 proceeds to the next Step 2238, adds 1 to the number m, returns to the previous Step 2242 in FIG. 19C, and repeats the above-described processing.

If the determination at Step 2237 is NO, the CPU 1020 proceeds to Step 2201 in FIG. 19A and executes the above-described processing.

As described above, the network anomaly detection apparatus 100 in Embodiment 3 executes Algorithm 1 (FIGS. 7A and 7B) that detects an anomaly in accordance with the sequence from Flow One to Flow Two, like in the foregoing Embodiment 1, if none of the IP addresses of the known C & C servers 400 is included in the flow statistical records 51. However, if one or more of the IP addresses of the known C & C servers 400 are included in the flow statistical records 51, the network anomaly detection apparatus 100 executes Algorithm 2 (FIGS. 8A and 8B) that detects an anomaly in accordance with the sequence from Flow Two to Flow One and thereafter, executes Algorithm 1 (FIGS. 7A and 7B).

Through this configuration, the network anomaly detection apparatus 100 can detect events each concerning a plurality of flows in chronological order by examining a reduced number of flow statistical records 51 and unfailingly detect activity of a botnet where detected events concerning a plurality of flows occur in a specific order.

### SUMMARY AND SUPPLEMENTAL REMARKS

As set forth above, the network anomaly detection apparatus (100) in the foregoing Embodiments 1 to 3 is a network anomaly detection apparatus (100) having a processor (1020) and a memory (1021) to detect an anomaly of a network (200) to be monitored based on received flow statistical information. The network anomaly detection apparatus (100) includes a statistical information collection unit (101) configured to receive flow statistical information aggregated from header information of packets in the network and collect the flow statistical information in a flow statistical information storage unit (50), scenario information (20) including a scenario (21) in which a time-series sequential relation of events concerning a plurality of flows is defined, and an anomaly detection unit (102) configured to acquire flow statistical information (51) in a predetermined period from the flow statistical information storage unit (50) and determine whether any anomaly exists in the network (200) based on whether any flow statistical information (51) matching the events in the scenario (21) of the scenario information (20) exists.

As a result, the network anomaly detection apparatus 100 can detect events each concerning a different flow in chronological order and further, unfailingly detect an anomaly (cyber kill chain) in the network 200 or a sign of an anomaly where detected events concerning different flows occur in a specific order.

In the network anomaly detection apparatus (100), the scenario (21) includes flow conditions (22, 24) for a plurality of events, threshold conditions (23, 25) predetermined for the plurality of events, and sequential relations (26, 27) of the plurality of events. Each of the flow conditions (22, 24) includes information on a source (54) or a destination (55), each of the threshold conditions (23, 25) includes a threshold related to a quantity when the flow condition occurs, and the sequential relation (26, 27) includes a chronological time relation of the plurality of events.

As a result, the network anomaly detection apparatus 100 can detect an anomaly or a sign of an anomaly in the network 200 with a scenario entry 21 in which some of the steps of a cyber kill chain of Reconnaissance, Weaponization, Delivery, Exploitation, Installation, Command and Control (C & C), and Actions on Objective are defined.

The anomaly detection unit (102) provides a user interface to configure the scenario information (20). As a result, the user of the network anomaly detection apparatus 100 can add or amend a step or a feature of a cyber kill chain as needed.

The anomaly detection unit (102) is configured to output information on flow statistical information (51) matching the events in the scenario (21) as log information (71) indicating occurrence of an anomaly, if such flow statistical information (51) matching the events in the scenario exists. Outputting information about an anomaly in the network 200 enables the specifics of the anomaly to be displayed with a visualization server 120.

The flow statistical information is information generated with NetFlow from header information of packets. Hence, the network anomaly detection apparatus 100 can detect an anomaly or a sign of an anomaly in the network 200 based on the information collected by an existing network apparatus.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

What is claimed is:

1. A network anomaly detection apparatus configured to detect an anomaly of a network to be monitored based on received flow statistical information, the network anomaly detection apparatus comprising:
a processor;
a memory;
a statistical information collection unit configured to receive flow statistical information aggregated from header information of packets in the network and collect the flow statistical information in a flow statistical information storage unit;
scenario information including a scenario in which a time-series sequential relation of events concerning a plurality of flows is defined; and
an anomaly detection unit configured to acquire flow statistical information in a predetermined period from the flow statistical information storage unit and determine whether any anomaly exists in the network based on whether any flow statistical information matching the events in the scenario of the scenario information exists.

2. The network anomaly detection apparatus according to claim 1,
wherein the scenario includes flow conditions for a plurality of events, threshold conditions predetermined for the plurality of events, and a time-series sequential relation of the plurality of events,
wherein each of the flow conditions includes information on a source or a destination,
wherein each of the threshold conditions includes a threshold related to a quantity when the flow condition occurs, and
wherein the sequential relation includes a chronological time relation of the plurality of events.

3. The network anomaly detection apparatus according to claim 1, wherein the anomaly detection unit provides a user interface to configure the scenario information.

4. The network anomaly detection apparatus according to claim 1, wherein the anomaly detection unit is configured to output information on flow statistical information matching the events in the scenario as log information indicating occurrence of an anomaly if such flow statistical information matching the events exists.

5. The network anomaly detection apparatus according to claim 1, wherein the flow statistical information is information generated with NetFlow from header information of packets.

6. A network anomaly detection system comprising:
a network to be monitored;
a relay apparatus in the network; and
a network anomaly detection apparatus including a processor and a memory,
wherein the relay apparatus is configured to generate flow statistical information from header information of packets in the network and send the generated flow statistical information to the network anomaly detection apparatus,
wherein the network anomaly detection apparatus is configured to detect an anomaly in the network based on flow statistical information received from the relay apparatus, and
wherein the network anomaly detection apparatus includes:
a statistical information collection unit configured to receive flow statistical information aggregated from header information of packets in the network and collect the flow statistical information in a flow statistical information storage unit;
scenario information including a scenario in which a time-series sequential relation of events concerning a plurality of flows is defined; and
an anomaly detection unit configured to acquire flow statistical information in a predetermined period from the flow statistical information storage unit and determine whether any anomaly exists in the network based on whether any flow statistical information matching the events in the scenario of the scenario information exists.

7. The network anomaly detection system according to claim 6, wherein the relay apparatus includes:
a mirroring device configured to output mirror packets of packets in the network; and
an information collection device configured to receive the mirror packets output from the mirroring device and generate flow statistical information based on header information.

8. A network anomaly detection method for a computer having a processor and a memory to detect an anomaly in a network to be monitored based on received flow statistical information, the network anomaly detection method comprising:
a first step of receiving, by the computer, flow statistical information aggregated from header information of packets in the network and collecting, by the computer, the flow statistical information in a flow statistical information storage unit;
a second step of acquiring, by the computer, flow statistical information in a predetermined period from the flow statistical information storage unit; and
a third step of determining, by the computer, whether any anomaly exists in the network based on whether any flow statistical information matching events in a scenario of scenario information exists, the scenario defining a time-series sequential relation of events concerning a plurality of flows.
